(19) United States
(12) Patent Application Publication
(10) Pub. No.: US 2018/0099510 A1
(43) Pub. Date: Apr. 12, 2018

(54) INKJET APPARATUS AND METHOD FOR DENSITY CORRECTION IN INKJET APPARATUS

(71) Applicant: Yukihito Niino, Tokyo (JP)

(72) Inventor: Yukihito Niino, Tokyo (JP)

(73) Assignee: Ricoh Company, Ltd., Tokyo (JP)

(21) Appl. No.: 15/724,192

(22) Filed: Oct. 3, 2017

(30) Foreign Application Priority Data
Oct. 7, 2016 (JP) 2016-199574

(51) Int. Cl. B41J 2/205; B41J 2/14; B41J 2/21

(52) U.S. Cl. CPC B41J 2/2054; B41J 2/1607; B41J 2/2121; B41J 2/14

(57) ABSTRACT

An inkjet apparatus includes a plurality of heads to discharge droplets from a plurality of nozzles of the plurality of heads to form an image on a medium, a head driver to generate a drive waveform to discharge the droplets from the plurality of nozzles of the plurality of heads, a scanner to read a specific pattern from the image on the medium formed by the droplets discharged from the plurality of nozzles of the plurality of heads, and a discharge amount adjuster to correct the drive waveform to reduce differences in discharge amount of the droplets between the plurality of heads according to the specific pattern read by the scanner.

### CROSS-REFERENCE TO RELATED APPLICATION

This patent application is based on and claims priority pursuant to 35 U.S.C. § 119(a) to Japanese Patent Application No. 2016-199574, filed on Oct. 7, 2016 in the Japan Patent Office, the entire disclosures of which is hereby incorporated by reference herein.

### BACKGROUND

### Technical Field

Aspects of the present disclosure relate to an inkjet apparatus and a method for density correction in an inkjet apparatus.

### Related Art

A recording head or a discharge head (hereinafter, simply referred to as “head”) is used in an inkjet image forming apparatus. The head discharges liquid droplets (ink) from nozzles formed in the nozzle face of the head. There can arise variation (unevenness) in discharge speed and discharge amount between the heads and between nozzles in the same head owing to manufacturing error, for example, which can easily generate unevenness in the density of the image formed. This density unevenness cannot be ignored particularly in a line-head type of image forming apparatus that performs one-pass printing, in which the heads are arranged across the sheet width and do not move while printing.

### SUMMARY

In an aspect of this disclosure, a novel inkjet apparatus includes a plurality of heads to discharge droplets from a plurality of nozzles of the plurality of heads to form an image on a medium, a head driver to generate a drive waveform to discharge the droplets from the plurality of nozzles of the plurality of heads, a scanner to read a specific pattern from the image on the medium formed by the droplets discharged from the plurality of nozzles of the plurality of heads, and a discharge amount adjuster to correct the drive waveform to reduce differences in discharge amount of the droplets between the plurality of heads according to the specific pattern read by the scanner.

In still another aspect of this disclosure, a method for density correction in an inkjet apparatus, the method includes discharging droplets from a plurality of nozzles of a plurality of the heads to form an image on a medium, generating a drive waveform to discharge the droplets from the plurality of nozzles, reading a specific pattern from the image on the medium formed by the droplets discharged from the plurality of nozzles of the plurality of heads, and correcting the drive waveform to reduce differences in discharge amount of droplets between the plurality of heads according to the specific pattern.

In still another aspect of this disclosure, an inkjet apparatus includes a plurality of heads to discharge droplets from a plurality of nozzles of the plurality of heads to form an image on a medium, a head driver to generate a drive waveform to discharge the ink droplets from the plurality of nozzles, a scanner to read a specific pattern from the image on the medium formed by the droplets discharged from the plurality of nozzles of the plurality of heads, and a discharge amount adjuster to correct the drive waveform to reduce differences in discharge amount of droplets between the plurality of nozzles in one head among the plurality of heads according to the specific pattern read by the scanner.

### BRIEF DESCRIPTION OF THE SEVERAL VIEWS OF THE DRAWINGS

The aforementioned and other aspects, features, and advantages of the present disclosure will be better understood by reference to the following detailed description when considered in connection with the accompanying drawings, wherein:

FIG. 1 is a schematic view of an image forming apparatus according to a first embodiment of the present disclosure;

FIG. 2 is a bottom view of heads according to the first embodiment;

FIG. 3 is a schematic diagram of hardware of the image forming apparatus according to the first embodiment;

FIG. 4 is a functional block diagram of a drive waveform control system of the heads according to the first embodiment;

FIG. 5 is a flowchart of a process of ink discharge amount correction between the heads according to the first embodiment;

FIG. 6 is schematic view of a test pattern for testing satellite droplets on a medium;

FIG. 7 illustrates the drive waveform used for discharge amount correction;

FIGS. 8A, 8B, and 8C illustrate a plurality of drive waveforms corrected within a common drive waveform;

FIGS. 9A, 9B, 9C, and 9D are schematic views illustrating the landing-position adjustment process;

FIG. 10 is a flowchart of the discharge amount correction between the heads in the head according to the first embodiment;

FIGS. 11A, 11B, 11C, and 11D illustrate specific dot patterns used for inspection;

FIG. 12 illustrate specific dot patterns formed by plurality types of droplet size used for the inspection;

FIGS. 13A and 13B illustrate images formed on the sheet and image obtained by reading the image;

FIG. 14 is a flowchart of the discharge amount correction between the heads according to a second embodiment;

FIGS. 15A, 15B, and 15C illustrate specific staggered arrangement patterns as an inspection chart in the second embodiment;

FIGS. 16A, 16B, and 16C illustrate an example of read image obtained by reading the staggered arrangement pattern in FIGS. 15A through 15C;

FIG. 17 is a graph that illustrates a relation between the black color density and a voltage magnification;

FIG. 18 is a flowchart of the discharge amount correction between the heads according to a third embodiment;

FIG. 19 illustrates a gradation chart including halftone image detected by the third embodiment;

FIG. 20 is a correlation graph between density and a voltage magnification;

FIG. 21 is a correlation graph between density and a voltage magnification with finer magnification than the magnification of FIG. 20;

FIGS. 22A and 22B illustrate a density difference between the heads according to a gradation adjustment in comparative example;

FIGS. 23A, 23B, and 23C are flowcharts illustrating steps in a process of the discharge amount correction of variation of the present embodiment; and

FIGS. 24A, 24B, 24C, and 24D are flowcharts illustrating steps in a process of the discharge amount correction of another variation of the present embodiment.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

In describing embodiments illustrated in the drawings, specific terminology is employed for the sake of clarity. However, the disclosure of this patent specification is not intended to be limited to the specific terminology so selected and it is to be understood that each specific element includes all technical equivalents that have the same function, operate in a similar manner, and achieve similar results.

Although the embodiments are described with technical limitations with reference to the attached drawings, such description is not intended to limit the scope of the disclosure and all of the components or elements described in the embodiments of this disclosure are not necessarily indispensable. As used herein, the singular forms “a”, “an”, and “the” are intended to include the plural forms as well, unless the context clearly indicates otherwise.

Referring now to the drawings, wherein like reference numerals designate identical or corresponding parts throughout the several views, embodiments of the present disclosure are described below.

Below, embodiments of the present disclosure are described with reference to the attached drawings.

Printing System

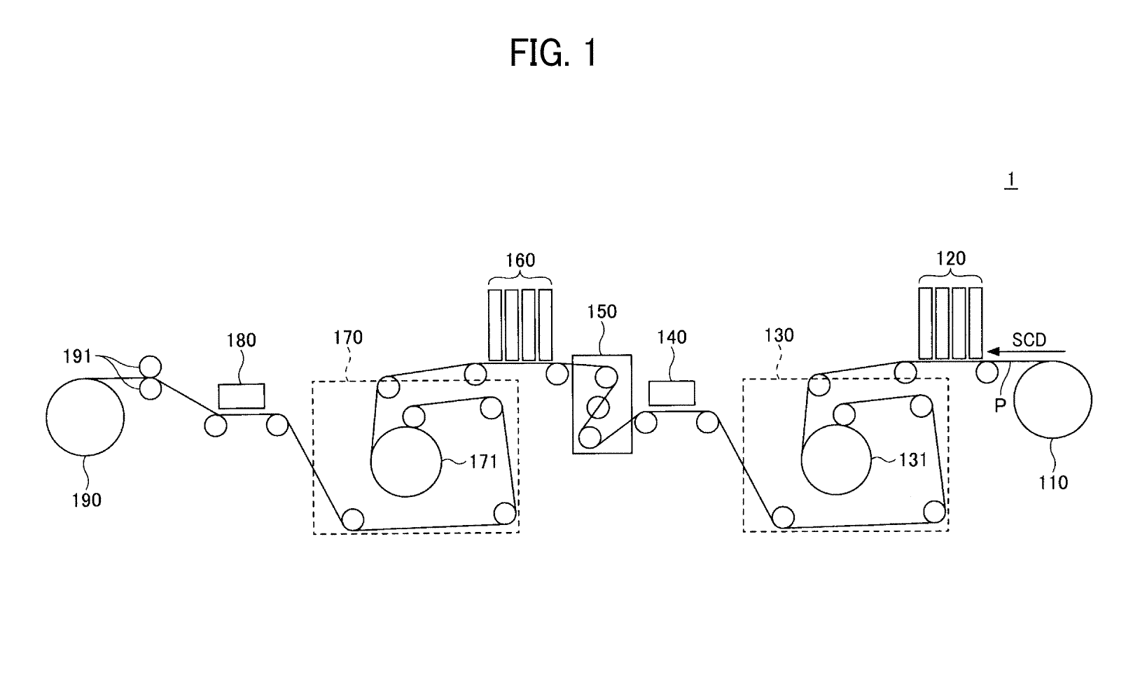

FIG. 1 is a schematic general view of a printing system 1 as an inkjet apparatus. In FIG. 1, as an example of printing system 1 according to an embodiment of the present disclosure, an inkjet apparatus for printing on a medium of continuous form is illustrated. Specifically, a mechanical part that performs an operation such as image formation is illustrated in FIG. 1. A description is given of a general configuration of the printing system with reference to FIG. 1.

The printing system 1 includes a feeder 110, a front-face printing mechanism 120, an after-drying mechanism 130, a scanner 140, a reversal mechanism 150, a back-face printing mechanism 160, an after-drying mechanism 170, a scanner 180, and a winding device 190, arranged from right to left in FIG. 1.

The sheet P as a recording medium (discharged object) is fed from an unwinder device of the feeder 110 and reached to the front-face printing mechanism 120 that performs printing on a front face (first face) of the sheet P. The sheet P is conveyed from right to left in FIG. 1 in a sheet conveyance direction (SCD).

A mechanism to apply treatment liquid (pre-treatment liquid) on a recording face of the sheet P may be provided (inserted) between the feeder 110 and the front-face printing mechanism 120. The treatment liquid controls permeability of ink to the recording face of the sheet P.

The sheet P that passes through the front-face printing mechanism 120 passes the after-drying mechanism 130 and the scanner 140. The after-drying mechanism 130 dries the front-face (recording face) of the sheet P.

In the present embodiment, the after-drying mechanism 130 is a heat drum 131 that contacts and heats the sheet P from the back side of the sheet P, as an example. The heat temperature of the heat drum 131 is set from about 50 to 100 degrees Celsius according to a printing speed and a drying property of ink. The after-drying mechanism 130 may use hot air, infrared rays, a press, or ultraviolet rays for drying. The after-drying mechanism 130 may have at least one of the above-described drying means combined with the heat drum 131.

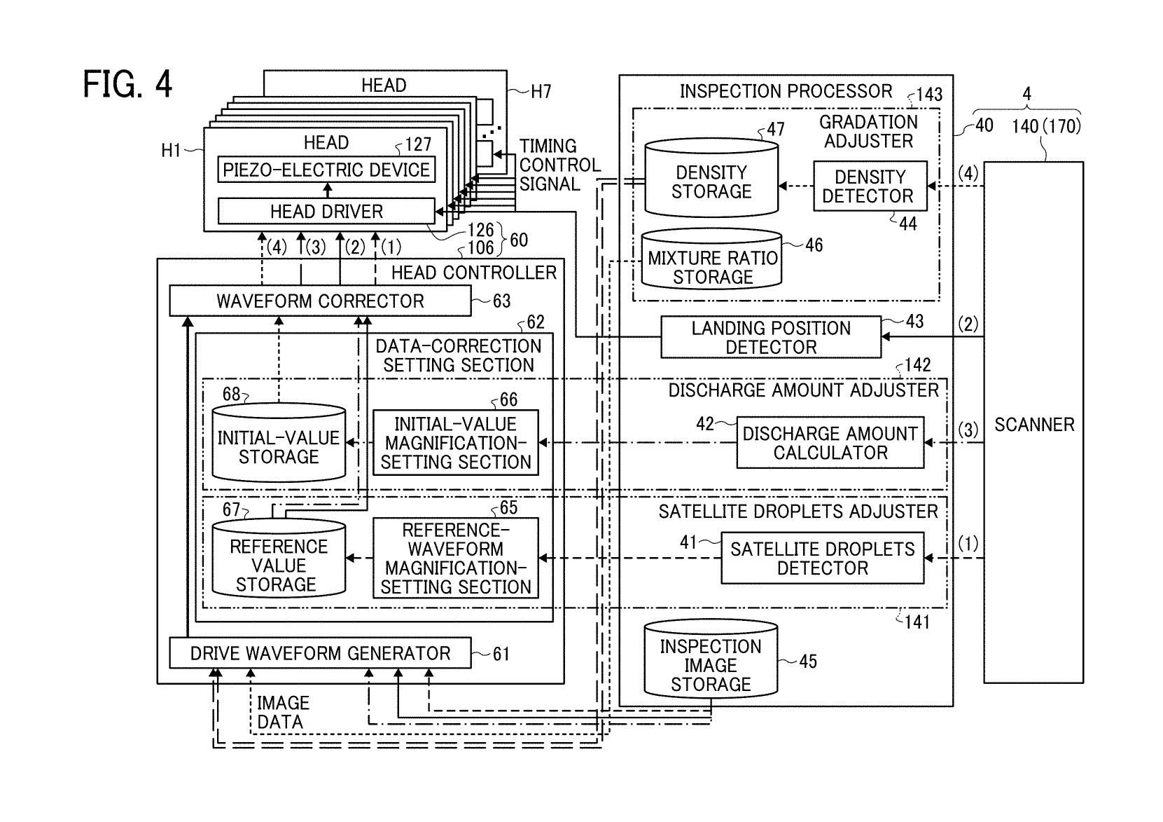

The scanner 140 is disposed downstream of the after-drying mechanism 130 and upstream of the reversal mechanism 150. The scanner 140 reads an image that is used for inspection to adjust discharge timings between heads. An image inspection mechanism 4 includes a mechanism (reading device) to read color information of image read by the scanner 140 and a control mechanism (inspection processor 40 illustrated in FIG. 4) to process the color information read by the scanner 140.

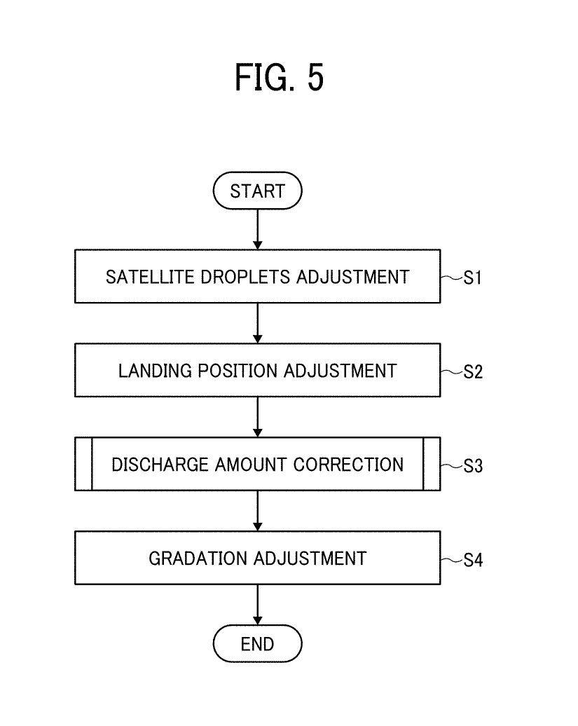

The scanner 140 illustrated in FIG. 1 is a reading device (imaging device) of the image inspection mechanism 4. The scanner 140 reads an inspection image (inspection chart) to adjust the density difference between the heads as illustrated in the flowchart shown in FIG. 5. For example, the scanner 140 includes a Charge Coupled Device (CCD) camera. The scanner 140 is mounted to the printing system 1 to film entire width of the sheet P. A plurality of the scanner 140 may be mounted to the printing system 1 with arbitrary interval in the sheet width direction of the sheet P.

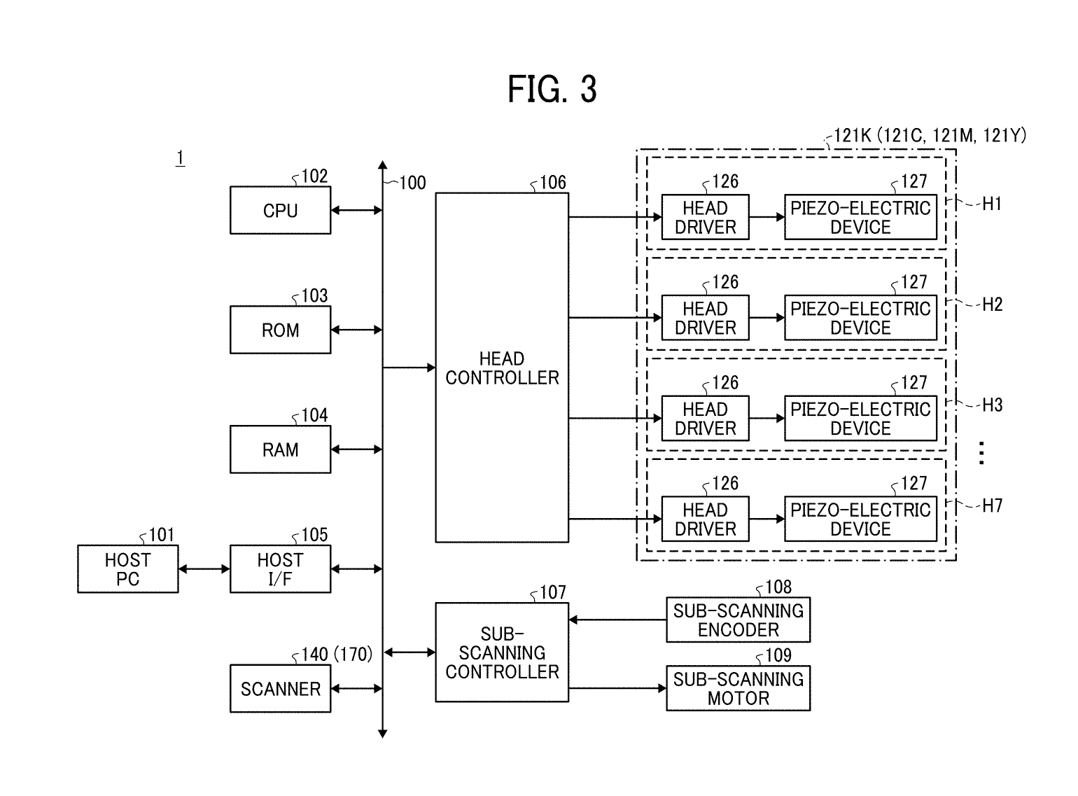

The image information read by the scanner 140 is calculated in one of a control mechanism in the image inspection mechanism 4, a controller in the printing system 1, or host PC 101 for the color information of the image read by the scanner 140. The host PC 101 is a computer connected to the printing system 1 as illustrated in FIG. 3. A digital Front End (DFE) is an example of the host PC 101. The control mechanism of the image inspection mechanism 4 may be used in-line or off-line.

Then, the sheet P passes through the reversal mechanism 150, the back-face printing mechanism 160, the after-drying mechanism 170, and the scanner 180. The reversal mechanism 150 reverses front and back side of the sheet P. The back-face printing mechanism 160 prints image on a back-face (second face) of the sheet P. The after-drying mechanism 170 dries the back-face of the sheet P on which an image is printed.

The process of density adjustment between heads for the back-face of the sheet P is performed by the scanner 180 and the image inspection mechanism 4. The scanner 180 acts as reading device and has a similar function with the above-described image inspection mechanism 4. The image inspection mechanism 4 includes a controller that is an inspection processor 40 illustrated in FIG. 4.

Finally, the sheet P is wound around by the winding device (rewinder) 190 that is an example of a post-processing apparatus. The post-processing apparatus processes the sheet P after printing. According to the contents of the post-processing after the printing, an export process may be performed instead of rewinding process. The export process includes cutting operation to cut the sheet P with a cutter.

In addition to the above-described configuration, a pre-processing mechanism and a pre-processing liquid drying mechanism may be provided at upstream of the front-face printing mechanism 120 and the back-face printing mechanism 160. The pre-processing mechanism (pre-processing liquid application apparatus) applies pre-processing liquid on the sheet P. The pre-processing liquid has a function of aggregation of ink on the sheet P. The pre-processing liquid drying mechanism dries the pre-processing liquid applied on the sheet P.

Further, post-processing mechanism (post-processing liquid application mechanism) may be provided at downstream side of the front-face printing mechanism 120 and the back-face printing mechanism 160 and upstream side of the after-drying mechanism 130 and 170. The post-processing mechanism applies post-processing liquid on the sheet P. The post-processing liquid prevents peeling of image (ink) from the sheet P.

The printing system 1 may be connectable with the external computer such as host PC 101 as illustrated in FIG. 3, and image data, etc., may be transferred from the external computer to the printing system 1.

Head Configuration

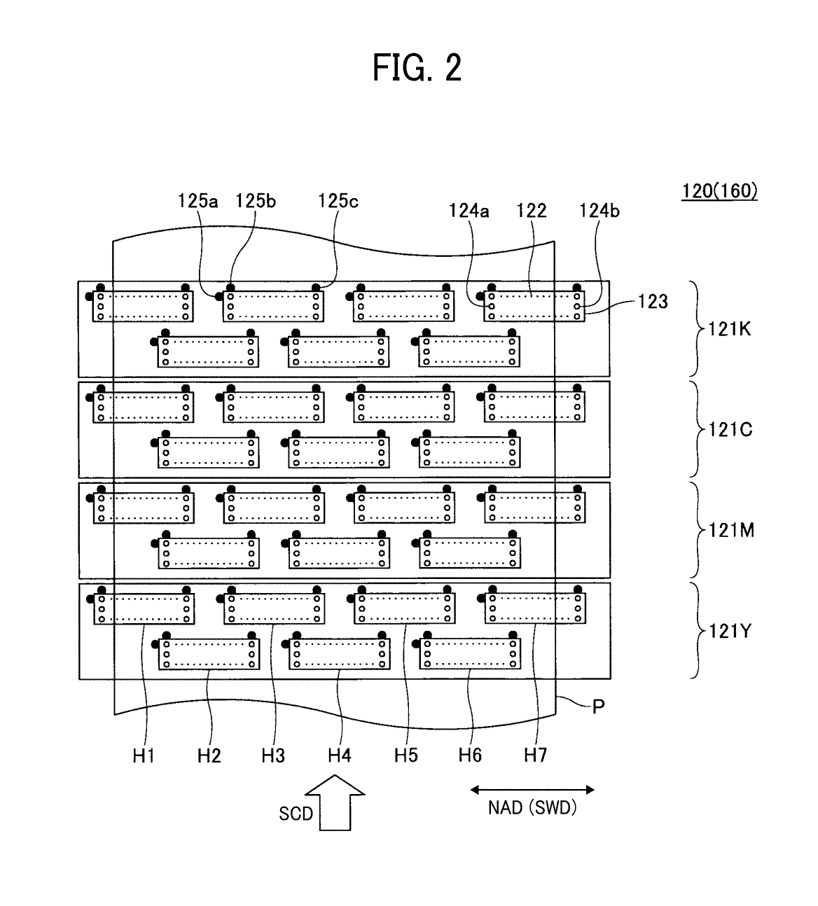

FIG. 2 is a bottom view of an example of recording heads according to the present embodiment. A plurality of recording heads (hereinafter, simply referred to “heads”) is arranged to form a line-head configuration in which the plurality of heads is arranged in a sub-scanning direction (SWD) perpendicular to the sheet conveyance direction (SCD) to cover a width of the sheet P. The sub-scanning direction is parallel with the nozzle array direction (NAD) of the plurality of heads. Specifically, FIG. 2 is a plan view of the front-face printing mechanism 120 and the back-face printing mechanism 160 illustrated in FIG. 1 seen from below. In FIG. 2, the plurality of recording heads is arranged in staggered manner.

The sheet P is conveyed to the front-face printing mechanism 120 and the back-face printing mechanism 160 with plurality of rollers in a direction indicated by an arrow illustrated in FIG. 1. The front-face printing mechanism 120 is used in the following description because the configuration of the front-face printing mechanism 120 and the back-face printing mechanism 160 is about the same. As illustrated in FIG. 2, the front-face printing mechanism 120 includes four head units 121K, 121C, 121M, and 121Y that are configured with the inkjet line-heads of single-path type. The inkjet line-heads of single-path type can print image on the sheet P while fixing the position of the heads. Thus, it is not necessary to move the heads in a main scanning direction during printing.

The head units 121K, 121C, 121M, and 121Y discharge ink droplets of basic colors such as black (K), cyan (C), magenta (M), and yellow (Y), respectively, to form an image on the sheet P. Hereinafter, the head units 121K, 121C, 121M, and 121Y are simply referred to as head units 121. The front-face printing mechanism 120 may further include a head unit 121 that discharges liquid of specific (special) color such as orange or violet or a head unit 121 that discharges a liquid droplet for over-coating to apply glossy coating or other processes on the sheet P.

The head units 121 should have a size greater than a width of the sheet P. Thus, a plurality of heads (for example, heads H1 to H7 illustrated in FIG. 2) is joined together to configure the head units 121. The heads H1 to H7 and nozzles 122 in the heads H1 to H7 exhibit unevenness (irregularity) in discharge characteristics. Thus, color difference (color unevenness) is occurred between the heads H1 to H7 or between nozzle arrays in the heads H1 to H7. Therefore, it is necessary to adjust the discharge characteristic between the heads to correct the color unevenness (density unevenness) between the heads H1 to H7.

The head units 121 are retractable (separable) from a sheet conveyance path. A maintenance operation of the heads H1 to H7 of the head units 121 is performed while the head units 121 are retracted from the sheet conveyance path. The maintenance operation cleans nozzle faces of the heads H1 to H7 and operates the heads H1 to H7 to discharge thickened ink from the nozzles 122.

Each of the heads H1 to H7 includes two nozzle arrays. Nozzles (nozzle orifices) 122 are arranged at equal intervals (600 dpi, for example) in the width direction of the sheet P (nozzle array direction (NAD) in FIG. 2) in each nozzle arrays illustrated as dots in FIG. 2.

Ink droplets are discharged from the nozzles 122 of the heads H1 to H7. The nozzles 122 are arranged in row to form the nozzle array of the heads H1 to H7. Two rows of seven heads H1 to H7 are arranged in staggered manner in each of the head units 121K, 121C, 121M, and 121Y in a direction perpendicular to the sheet conveyance direction (SCD) on a plate shaped base frame 123. Both ends of each of the heads H1 to H7 are fixed to the base frame 123 of the head units 121 with screws 124a and 124b.

In each colors of head units 121K, 121C, 121M, and 121Y, the heads H1 to H7 may be further arranged in the nozzle array direction (NAD), which is parallel to the width direction of the sheet P (lateral direction) in FIG. 2, according to the width of the sheet P to be used.

A position in the sheet conveyance direction (SCD) and in the nozzle array direction (NAD) of each of the heads H1 to H7 is determined by a position determining face 125a, 125b, and 125c. The position determining face 125a, 125b, and 125c are provided on three places on the base frame 123 as illustrated by black circle in FIG. 2.

In the present embodiment, as illustrated in FIG. 2, different colors such as four colors (Y, M, C, and K) of the head units 121Y, 121M, 121C, and 121K are arranged in the sheet conveyance direction (SCD) of sheet P and are fixed to a main frame with screws.

FIG. 2 illustrates an example of arrangement of the heads H1 to H7 in staggered manner in each of the head units 121. However, alternatively the heads H1 to H7 may be arranged continuously such that the heads adjoining in the nozzle array direction (NAD) are in contact with each other in the nozzle array direction (NAD). Further, the heads H1 to H7 may include a plurality of rows (two rows, for example) of identical nozzle arrays.

In FIG. 2, a line-type image-forming apparatus is used for describing the inkjet apparatus of the present embodiment. The line-type image-forming apparatus forms images using a line-type head that remains stationary while ejecting ink droplets. However, alternatively the inkjet apparatus may be a serial-type image-forming apparatus that forms images using a serial-type head that ejects ink droplets while moving in a main scanning direction (width direction of the sheet P or nozzle array direction (NAD)).

As illustrated in FIG. 2, a line-type image-forming apparatus includes plurality of heads H1 to H7 arrayed in the width direction of the sheet P (nozzle array direction (NAD)) to form a head array. The heads H1 to H7 are arranged such that the nozzle arrays in the heads H1 to H7 are perpendicular to the sheet conveyance direction (SCD). In other words, the heads H1 to H7 are arranged such that the nozzle arrays in the heads H1 to H7 are arranged parallel with the width direction of the sheet P (nozzle array direction (NAD)). In the serial-type image-forming apparatus, a carriage that mounts the heads moves (scans) reciprocally in the main scanning direction (width direction of the sheet P) over the sheet P while printing. Further, the nozzle array in the head is arranged parallel to the sheet conveyance direction (SCD) in the serial-type image-forming apparatus.

The density correction system and method of the inkjet apparatus of the present embodiment described below is applicable to either the serial-type image forming apparatus or the line-type image forming apparatus.

Hardware Configuration

FIG. 3 is a block diagram illustrating an example of a basic structure of a hardware of the inkjet apparatus according to present embodiment.

With reference to FIG. 3, the printing system (inkjet apparatus) 1 is connectable with a host PC (personal computer, DFE) 101. The host PC transmits image data of print job via a host interface I/F 105 or network.

The printing system (inkjet apparatus) 1 includes a central processing unit (CPU) 102, a read only memory (ROM) 103, random access memory (RAM) 104, a host interface I/F 105, a head controller 106, a sub-scanning controller 107, a sub scanning encoder 108, a common bus 100, and the head units 121 as a hardware configuration of the printing mechanism 120 (160) of the inkjet apparatus in FIG. 1.

The common bus 100 connects the CPU 102, the ROM 103, the RAM 104, the host interface I/F 105, the head controller 106, and the sub-scanning controller 107. The common bus 100 further connects the parts described-above with the scanner 140 (180).

The CPU 102 controls each parts of the printing system (inkjet apparatus) 1. The ROM 103 is a memory for working storage.

The RAM 104 stores a control signal of a firmware that controls hardware for printing functions and also stores drive waveform data of the heads H1 to H7.

The non-volatile RAM 104 stores image data and gap information that indicates a deviation in landing positions of the ink droplets between the head arrays of the heads H1 to H7 during mounting the heads H1 to H7 in parallel on the head units 121 as a head array.

The RAM 104 also functions as a non-volatile storage that stores deviation information of the ink droplets landing positions between the head arrays arranged in parallel as the head array.

The head controller 106 generates a plurality of head-driving waveforms to discharge the ink droplets from the nozzles 122 of each head arrays within a predetermined drive cycle that corresponds to a sub-scanning resolution in the sheet conveyance direction (SCD). At the same time, the head controller 106 selects the head-driving waveforms based on the deviation information of the ink droplets landing positions to drive each of the heads H1 to H7.

The sub-scanning controller 107 controls a sub scanning motor 109 according to a sub-scanning amount (sub-scanning resolution) based on the position information of the sheet P for conveyance of the sheet P. The position information is obtained from the sub scanning encoder 108. The head units 121 include head drivers 126 respectively. The head drivers 126 are connected to the head controller 106. The head drivers 126 are driver of the heads H1 to H7. The head drivers 126 drive each piezo-electric device 127 based on data of the transferred head-driving waveform to discharge ink droplets from the heads H1 to H7.

With these line-type heads H1 to H7 illustrated in FIG. 2, the heads H1, H3, H5, and H7 are aligned in the main scanning direction (nozzle array direction (NAD)) with a space between each heads H1, H3, H5, and H7. Each of the spaces is smaller than a length of the nozzle array of the heads H1 to H7 in the nozzle array direction (NAD). Hereinafter, the head array of the heads H1, H3, H5, and H7 is referred to as a first head array.

A second head array includes heads H2, H4 and H6 that are aligned in the main scanning direction (nozzle array direction (NAD)) with a space between each heads H, H4, and H6. Each of the space is smaller than the length of nozzle array in the heads H1 to H7 in the nozzle array direction (NAD). Further, a space (gap) is provided between the first head array and the second head array in the sheet conveyance direction (SCD).

The head controller 106 generates a plurality of head-driving waveforms to discharge the ink droplets from the nozzles 122 of each heads H1 to H7 within a drive cycle of predetermined sub-scanning resolution in the sheet conveyance direction (SCD). At the same time, the head controller 106 selects the head-driving waveforms based on the deviation information of the ink droplets landing positions between the head arrays and applies the head-driving waveform on the head drivers 126 to drive each of the heads H1 to H7.

As a basic operation in this printing system (inkjet apparatus) 1, the CPU 102 receives image data of a print job from the host PC 101 via the host interface I/F 105 and the common bus 100 and stores the image data into the RAM 104.

When the head controller 106 receives a command from the CPU 102, the head controller 106 transfers image data stored in the RAM 104, the head-driving waveform for each heads H1 to H8 stored in the ROM 103, and the control signal to the head drivers 126 of the heads H1 to H7. This image data transfer is performed in linkage with the position information of the conveyed sheet P obtained via the sub-scanning controller 107 and common bus 100 from the sub scanning encoder 108.

The head drivers 126 of the heads H1 to H7 drives the piezo-electric devices 127 respectively based on the data selected from the plurality of head-driving waveforms transferred from the head controller 106 to discharge the ink droplets on the sheet P. Thus, the image data is printed on the sheet P. Therefore, the plurality of heads H1 to H7 discharge droplets from a plurality of nozzles 122 disposed on the plurality of heads H1 to H7 to form an image on a medium (sheet P).

As a method of controlling the deviation in the landing position, the head controller 106 generates a plurality of head-driving waveforms within a drive cycle of each heads H1 to H7. Further, the head controller 106 selects the head-driving waveforms to discharge ink droplets based on the gap information of the ink droplet landing position between the head arrays to drive each heads H1 to H7. Therefore, it is possible to adjust the deviation in the ink droplets landing position between the head arrays in the line-type image-forming apparatus with a finer accuracy than the sub-scanning resolution.

Functional Block

Next, an example of the scanner 140, the inspection processor 40, the head controller 106, and the heads H1 to H7 that constitute the image inspection mechanism 4 and a drive controller of an image forming mechanism are described with reference to FIG. 4.

FIG. 4 is a functional block diagram of a drive waveform control system of the heads H1 to H7.

The inspection processor 40 is a section to perform calculation in the image inspection mechanism 4. The inspection processor 40 includes a satellite droplets detector 41, a discharge amount calculator 42, a landing position detector 43, and a density detector 44.

Further, the inspection processor 40 includes an inspection image storage 45, a mixture ratio storage 46, and a density storage 47 as a storage section.

Part or all of inspection processing and drive control in image formation may be implemented by software (i.e., a computer program) or by hardware.

The head controller 106 commonly used for heads H1 to H7 and the head drivers 126 individually provided to each heads H1 to H7 are collectively function as the head driving section 60 to drive the heads H1 to H7.

The piezo-electric devices 127 and the head drivers 126 are provided inside the heads H1 to H7. The head driver 126 selects a drive pulse that constitutes a drive waveform provided from the head controller 106 based on the image data corresponding to one nozzle array of the heads H1 to H7 and generates a discharge pulse.

Then, the head driver 126 applies the discharge pulse to the piezo-electric devices 127 to drive the heads H1 to H7. The piezo-electric devices 127 act together as a pressure generator to generate energy to discharge liquid droplet (ink droplet) in the heads H1 to H7. At this point, part or all of the drive pulse constituting the drive waveform and part or all of the elements for waveform that forms the drive pulse are used to discharge droplets having different sizes, for example, large droplets, middle-sized droplets, small droplets so that dots having different size can be formed.

In the present embodiment, a piezo-type pressure generator is used as a pressure generator for compressing ink inside ink channel of the heads H1 to H7. The piezo-type pressure generator uses a piezoelectric element to deform a diaphragm to change a volume inside the ink channel and discharge ink from the nozzle. The diaphragm forms a wall face of the ink channel.

Note that the pressure generator is not limited to this configuration. For example, the pressure generator may be a thermal type that heats ink inside the ink channel using a heat generating resistor to generate bubble. Further alternatively, the pressure generator may be an electrostatic type in which a diaphragm and an electrode face each other. The diaphragm forms a wall face of the ink channel. An electrostatic force generated between the diaphragm and the electrode deforms the diaphragm and discharge ink droplets from the nozzles 122.

The head controller 106 includes a drive waveform generator 61, a data-correction setting section 62, and a waveform corrector 63.

The drive waveform generator 61 generates and outputs the drive waveform in a single printing cycle. The drive waveform includes a plurality of drive pulses (driving signal) in time series. The drive pulses contribute to form a plurality of sizes of droplets.

Specifically, the drive waveform generator 61 generates the drive waveform according to the image data. The image data includes image data for inspection. The drive waveform generator 61 acquires the image data for inspection from the inspection image storage 45, the mixture ratio storage 46, and the density storage 47, etc., during inspection process.

Here, as means for expressing gradation, halftone (halftone dots) express neutral color by adjusting size and density of patters such as dots according to a predetermined density (parameter) of 20%, 40%, 60%, and 80%, for example, for single color of black (K), cyan (C), magenta (M), and yellow (Y). KCMY density in a primary color that is a single color for constituting halftone is also referred to as CMYK density, Tone, solid density, film thickness, ink thickness, or component density. Specifically, shades of colors are expressed by the density and the size of the dots within a region that forms the halftone dot. A mixture ratio is prescribed for each parameter (%) as described below in Table 6.

The data-correction setting section 62 includes a reference-waveform magnification-setting section 65, an initial-value magnification-setting section 66, a reference value storage 67, and an initial-value storage 68.

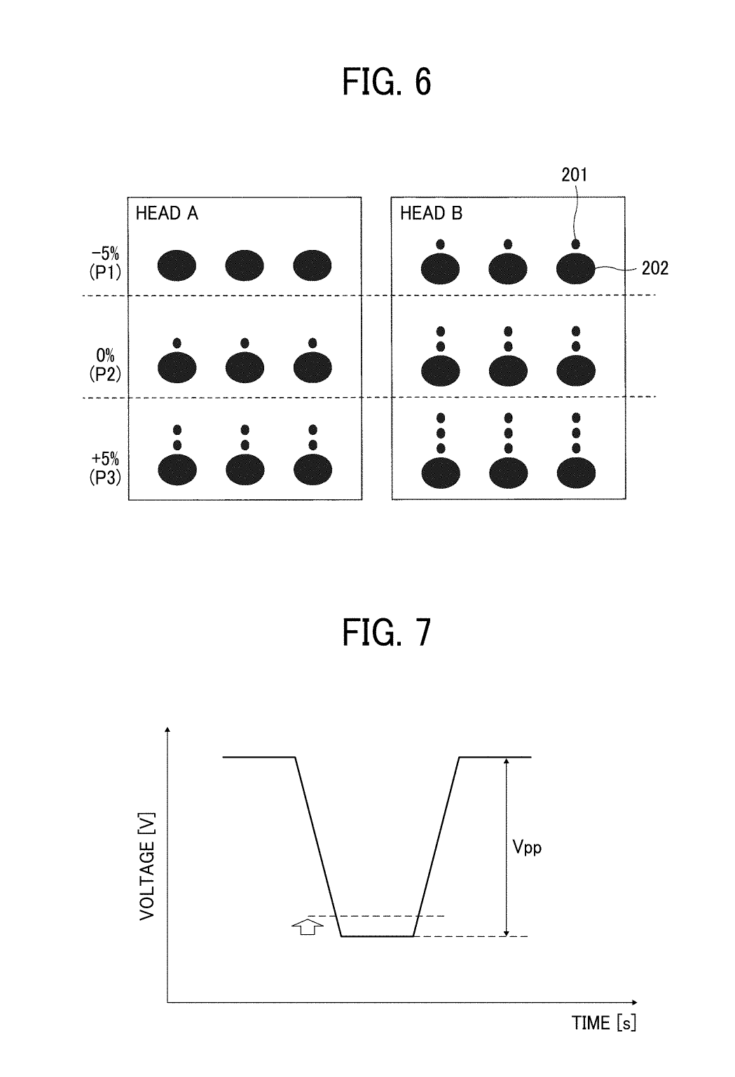

In the present system, the satellite droplets detector 41, the reference-waveform magnification-setting section 65, and the reference value storage 67 function as a satellite droplets adjuster 141. The satellite droplets adjuster 141 executes a step 51 depicted in the flowchart shown in FIG. 5, and the specification of an operation described below with reference to FIGS. 6 to 8.

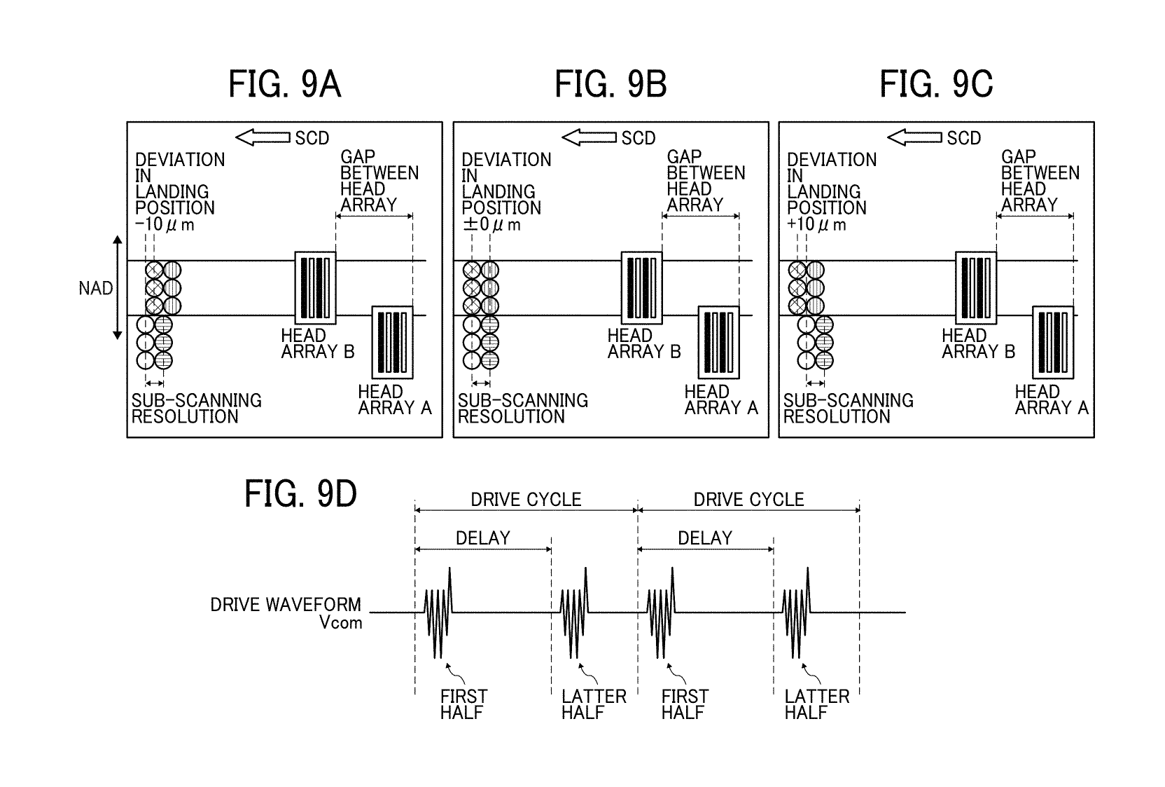

The landing position detector 43 executes a step S2 of an process in FIG. 5 together with the above-described sub-scanning controller 107 (See FIG. 3) in the sub-scanning direction, and the specification of an operation of which is described below with reference to FIG. 9.

The discharge amount calculator 42, the initial-value magnification-setting section 66, and the initial-value storage 68 function as a discharge amount adjuster 142. The discharge amount adjuster 142 executes a step S3 of the process in FIG. 5, and the specification of an operation of which is described below with reference to FIGS. 7 and 10-21.

The density detector 44, the mixture ratio storage 46, and the density storage 47 function as a gradation adjuster 143. The gradation adjuster executes a step S4 of the process in FIG. 5.

Process

FIG. 5 is a flowchart of steps in a density correction process as between the heads H1 to H7 according to the present embodiment.

First, the satellite droplets adjuster 141 performs satellite adjustment in step S1.

Specifically, as indicated by arrow (1) in FIG. 4, the drive waveform generator 61 acquires the image data read from the inspection image storage 45 and generates the drive waveform and output to the heads H1 to H7 via the waveform corrector 63 to discharge ink droplets so that an image for inspection (inspection chart) is formed on the sheet P.

The scanner 140 reads the image for inspection, and the satellite droplets detector 41 detects the satellite droplets. The reference-waveform magnification-setting section 65 calculates and sets an adjustment value of magnification of the drive voltage (amplitude) of drive waveform so that the number of the satellite droplets decreases. The reference-waveform magnification-setting section 65 temporally stores the adjustment value to the reference value storage 67 until an execution of the step S3.

Next, the landing position detector 43 performs a correction of droplet landing position between heads or between the nozzles in the head in step S2.

Specifically, as illustrated in FIG. 4, the drive waveform generator 61 acquires the image data read from the inspection image storage 45 and generates the drive waveform. The waveform corrector 63 corrects the drive waveform using the adjustment value of magnification (correction magnification) stored in the reference value storage 67 and outputs the corrected drive waveform to the heads H1 to H7 to discharge ink droplets so that image for inspection (inspection chart) is formed on the sheet P. The adjustment value of magnification (correction magnification) reflects the satellite droplets adjustment in step S1.

The scanner 140 reads the image for inspection. The landing position detector 43 corrects a landing position of the droplet between the heads in the sub-scanning direction. The landing position detector 43 directly sends a timing signal for adjusting the landing position of the droplet between the heads to each of the heads H1 to H7 so that each of the heads H1 to H7 sets the timing signal.

In step S3, the discharge amount adjuster 142 adjusts a difference in discharge amount between heads and between nozzles 122 in the heads H1 to H7. The process in step S3 may include three types of embodiments from a first embodiment to a third embodiment.

Specifically, as illustrated in FIG. 4, the drive waveform generator 61 acquires the image data read from the inspection image storage 45 and generates the drive waveform. Then, the waveform corrector 63 outputs and corrects the drive waveform using the correction magnification stored in the reference value storage 67, on which the satellite droplets adjustment is performed, and outputs the corrected drive waveform to the heads H1 to H7. Then, each of the heads H1 to H7 discharges the ink droplets at a timing adjusted according to the timing signal and forms an image for inspection (inspection chart) on the medium P.

The scanner 140 reads the image and calculates a discharge amount (density) of each of the heads H1 to H7 (and each of the nozzles 122 in the head) by the discharge amount calculator 42. Then, the initial-value magnification-setting section 66 calculates and sets a magnification of amplitude for each heads H1 to H7. Then, the initial-value storage 68 stores the corrected magnification of amplitude for each droplet size of the drive waveform.

In step S4, the gradation adjuster 143 performs a gradation adjustment to adjust an unevenness of density of the color and shading correction, for example.

Specifically, as illustrated in FIG. 4, the drive waveform generator 61 acquires the image data read from the mixture ratio storage 46 and generates the drive waveform. Then, the waveform corrector 63 corrects the drive waveform using the corrected magnification stored in the initial-value storage 68 and outputs the corrected drive waveform. The corrected magnification reflects the discharge amount correction in step S3 adjusted by the discharge amount adjuster 142. Then, each of the heads H1 to H7 discharges the ink droplets of the corrected discharge amount at the timing corrected by the timing signal.

The scanner 140 reads the gradation image. The density detector 44 detects a density of the gradation image for each heads H1 to H7 and each nozzles 122. The density detector 44 further calculates a correction value of density and stores the correction value in the density storage 47.

In a gradation adjustment process performed during a printing operation after the inspection or during maintenance, the waveform corrector 63 corrects the drive waveform using the corrected magnification stored in the initial-value storage 68. The heads H1 to H7 discharges the ink droplets according to the corrected drive waveform to form an image. Further, when halftone is to be formed, the heads H1 to H7 discharge ink droplets using the density stored in the density storage 47 and the corrected magnification stored in the initial-value storage 68.

Here, the step S1 and the step S2 may be omitted, and only the step S3 and the step S4 may be executed.

Adjustment of Satellite Droplets

Referring to FIGS. 6 through 8, a process of adjustment of the satellite droplets executed in the step S1 in FIG. 5 is described in further detail below.

FIG. 6 is schematic diagrams illustrating an example of test patterns printed on the medium P.

FIG. 7 is a schematic diagram of an example of the drive waveform.

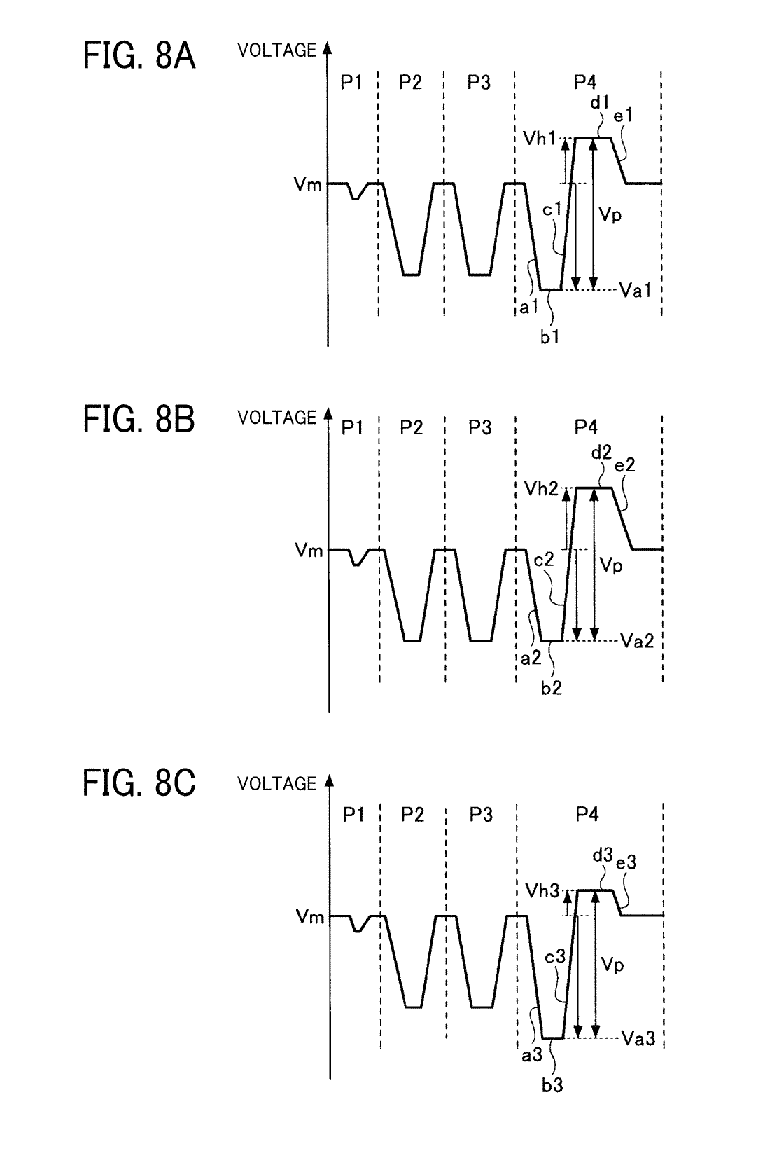

FIGS. 8A through 8C are schematic diagrams of another example of the drive waveforms.

As illustrated in FIG. 6, each of the head A (head H1, for example) and head B (head H2, for example) has a manufacturing error, for example. Thus, in the test patterns corresponding to each of the head A and head B, the number of accompanying droplets (satellite droplets) are different even the drive magnificent is identical for each of the heads A and B.

For example, the head A is driven in a drive magnification of zero percent in the test pattern in FIG. 6. This test pattern is assumed to be an ideal condition having one main droplet and one satellite droplet. When the test pattern of the head A driven in the drive magnification of zero percent is the ideal condition, the drive magnification of the head A is not corrected, and the drive magnification of the head B is corrected at −5% of the present set value of the drive magnification to discharge one main droplet and one satellite droplet. Previously, the head B discharges one main droplets with two satellite droplets in the drive magnification of zero percent.

The printing result of the head B approaches the ideal condition by correcting the drive magnificent of the head B with fewer satellite droplets from two to one. Therefore, the reference-waveform magnification-setting section 65 of the satellite droplets adjuster 141 compares a length of a droplet image when the drive magnification is zero percent in the head B and an ideal value of the droplet image. Then, the reference-waveform magnification-setting section 65 corrects the drive magnification of the head B to −5% according to the difference obtained by the comparison.

Here, in the comparison between the droplet image and the initial value, it is preferable to use a plurality of images when a control of heads H1 to H7 is performed based on the identical drive voltage. For example, the reference-waveform magnification-setting section 65 calculates an average value of the length of a plurality the droplet images of the head B, the drive magnification of which is zero percent.

The reference-waveform magnification-setting section 6 then compares the calculated average value and the ideal value and corrects the drive magnification of the head B to −5% based on the comparison result. Accordingly, the drive magnification can be more accurately corrected, and a stability of the discharge speed can be improved. The reference-waveform magnification-setting section 65 performs the correction process in the step S1 and stores the corrected value in the reference value storage 67.

FIG. 7 illustrates an example of the drive waveform used for correction.

It is known that a voltage amplitude Vpp of a trapezoid-shaped drive waveform has a proportional relation with a discharge speed and a discharge amount. That is, when the number of detected satellite is determined to be greater than the other heads or other nozzles 122 (head B in FIG. 6), the waveform corrector 63 reduces a voltage gain of the drive waveform and reduces the voltage amplitude Vpp in FIGS. 8A through 8C so that the discharge speed and the discharge amount can be corrected.

The example illustrated in FIG. 7 is a schematic example, and an actual drive waveform often incorporates a plurality of droplet types of waveforms within a common drive waveform.

FIGS. 8A through 8C illustrate an example of the plurality of drive waveforms corrected within the common drive waveform. FIG. 8A illustrates an example of a basic drive waveform. FIG. 8B illustrates an example of a first drive waveform obtained by correcting the basic drive waveform in FIG. 8A to increase the discharge amount. FIG. 8C illustrates an example of a second drive waveform obtained by correcting the basic drive waveform in FIG. 8A to decrease the discharge amount.

In FIG. 8, P1 is a micro-drive pulse for drying prevention and for maintenance, and P4 is a pulse for small droplets. Further, the pulse of P3+P4 is used to form a middle-sized droplet, and the pulse of P2+P3+P4 is used to form a large-sized droplet in the common drive waveform in FIGS. 8A through 8C. In these waveforms, a portion of P4 is used to correct the discharge amount because the pulse P4 is common for all the droplet sizes.

When the waveform is corrected as indicated in arrow in FIG. 7 such that the voltage amplitude Vpp is reduced, the discharge speed is changed with the change in the discharge amount. Thus, displacement in the landing position may occur when the amount of correction is large and the change in the discharge speed is large. Therefore, the discharge amount can be adjusted by changing the shape of the pulse P4 that is a common portion without changing the discharge speed.

For example, in order to increase the discharge amount, a rising potential Va2 of a trapezoid-shaped pulse projected downward is raised with respect to a reference potential Vm without changing a wave-height value Vp as illustrated in FIG. 8B. Here, the absolute value of the rising potential Va2 in FIG. 8B is smaller than the absolute value of the rising potential Va1 in FIG. 8A (|Va2|<|Va1|).

Further, a rising potential Vh2 of a trapezoid-shaped pulse (damping waveform) projected upward is raised such that the rising potential Vh2 in FIG. 8B is greater than a rising potential Vh1 in FIG. 8A (Vh2>Vh1). By raising a rising potential Va2, an expansion of a liquid room connected to the nozzle 122 by an expansion waveform element a2 is reduced. In other words, a drawing amount in the liquid room is reduced. Further, by raising a height of the rising potential Vh2, a contraction of the liquid room by a contraction waveform element c2 increases. In this way, the discharge amount can be increased without changing the discharge speed because pushing more from an initial position (reference potential Vm) in a section P3.

Contrarily, in order to decrease the discharge amount, a falling potential Va3 of a trapezoid-shaped pulse projected downward is lowered with respect to the reference potential Vm without changing the wave-height value Vp as illustrated in FIG. 8C. Here, the absolute value of the falling potential Va3 in FIG. 8C is greater than the absolute value of the rising potential Va1 in FIG. 8A (|Va3|>|Va1|). Further, a rising potential Vh3 of a trapezoid-shaped pulse projected upward is lowered such that the rising potential Vh3 in FIG. 8C is smaller than a rising potential Vh1 in FIG. 8A (Vh3<Vh1).

By lowering a falling potential Va3, the expansion of the liquid room by an expansion waveform element a3 is increased. In other words, a drawing ink amount in the liquid room is increased. Further, by lowering a height of the rising potential Vh3, a contraction of the liquid room by a contraction waveform element c3 decreases. In this way, the discharge amount can be decreased without changing the discharge speed because pushing less from an initial position (reference potential Vm) in the section P3.

In this way, the satellite droplets adjuster 141 corrects the drive magnification based on the test pattern illustrated in FIG. 6 in step S1. The discharge speed of each of the heads H1 to H7 is adjusted to form a droplet image with reduced density unevenness as same as the ideal condition on the recording medium P. As a result, the present embodiment can provide a stable discharge speed and good image quality. This adjustment method is specifically described in Japanese Patent Application Publication No. 2016-002662, for example.

The satellite adjustment of step S1 can be omitted because the satellite droplets can be detected together with the main droplets in case of the first embodiment described-below.

Landing Position Adjustment Process

Referring to FIGS. 9A through 9D, a process of adjusting deviation of landing positions of the ink droplets between the heads H1 to H7 executed in step S2 in the process in above-described FIG. 5 is described in further detail below. Hereinafter, the process of adjusting deviation in landing positions of ink droplets between the head arrays is simply referred to as a “landing-position adjustment process”.

The landing-position adjustment process in FIGS. 9A through 9D illustrates an example of controlling the deviation in the landing position of the ink droplets between the head arrays of the heads H1 to H7 by driving the heads H1 to H7 with the head controller 106. The landing position adjustment process also adjusts the deviation in the landing position of the ink droplets between arrays of nozzles 122 (nozzle array) in the heads H1 to H7.

FIGS. 9A through 9D are schematic views illustrating the landing-position adjustment process.

FIG. 9A illustrates a condition when an amount of deviation in the landing position of the ink droplet is less than zero (the position in the negative direction). As illustrated in FIG. 9A, the direction to the left with respect to the position in FIG. 9B is regarded as a negative direction. On the other hand, as illustrated in FIG. 9C, the direction to the right with respect to the position in FIG. 9B is regarded as a positive direction.

FIG. 9B illustrates a condition when an amount of deviation in the landing position of the ink droplet is equal to zero. If the value after the correction is less than the threshold value, this value is regarded as zero because the value smaller than the threshold value is difficult to be detected by the scanner 140.

FIG. 9C illustrates a condition when an amount of deviation in the islanding position of the ink droplet is greater than zero (the position in the positive direction).

FIG. 9D is a timing chart illustrating a status of adjusting a timing of driving waveform.

As illustrated in FIG. 2 and FIGS. 9A through 9D, a plurality of array of nozzles 122 (nozzle array) are arranged in each of the heads H2 and H3. In FIGS. 9A through 9D, the plurality of array of nozzles 122 arranged in the heads H2 is referred to as nozzle array B, and the plurality of array of nozzles 122 arranged in the heads H3 is referred to as a nozzle array A. As illustrated in FIG. 9A through 9C, the nozzle array A of the head H3 and the nozzle array B of the head H2 discharges ink droplets from each of the nozzles 122 of the nozzle array A and the nozzle array B to form an arrayed pattern in a direction paralleled with the nozzle array direction (NAD) on the medium P. The nozzle array direction (NAD) is an extension direction of the nozzle array A and B.

Specifically, the head controller 106 discharges ink droplets from the different nozzle arrays of the identical head to form an arrayed pattern on the medium P before performing the processes in FIGS. 9A through 9D. The scanner 140 reads the arrayed pattern.

Then, the landing position detector 43 determines whether there is a deviation in the landing position of the ink droplets between the nozzle arrays discharged from the different nozzle array in the head based on the arrayed pattern read by the scanner 140. By adjusting the discharge timing for each nozzle arrays, the head controller 106 adjusts the deviation of the landing position of the ink droplets between the nozzle arrays in the identical head.

Next, the head controller 106 discharges ink droplets from the different nozzle arrays A and B to form an arrayed pattern on the medium P as illustrated in FIGS. 9A through 9C. The scanner 140 reads the arrayed pattern.

Then, the landing position detector 43 determines whether there is a deviation in the landing position of the ink droplets between the nozzle arrays discharged from the different nozzle array A and B based on the arrayed pattern read by the scanner 140. By adjusting the discharge timing for each nozzle arrays, the head controller 106 adjusts the deviation of the landing position of the ink droplets between the nozzle arrays A and B.

In this way, as illustrated in FIG. 9D, during generating a plurality of the drive waveforms within a drive cycle corresponding to the sub-scanning resolution, it is preferable to output the head drive waveform after the second output with a predetermined delay (time interval) from the first output of the head drive waveform.

When a deviation of the landing positions is detected as illustrated in FIG. 9A or 9C, the head controller 106 adjusts this delay to adjust the discharge timing of ink droplets between the nozzle arrays A and B as illustrated in FIG. 9B.

This adjustment method is specifically described in Japanese Patent Application Publication No. 2016-022650, for example.

The process of adjusting the deviation of the landing position may be omitted when the plurality of heads are aligned in one line.

Discharge Amount Correction in a First Embodiment (When the Scanner is a High Resolution Scanner)

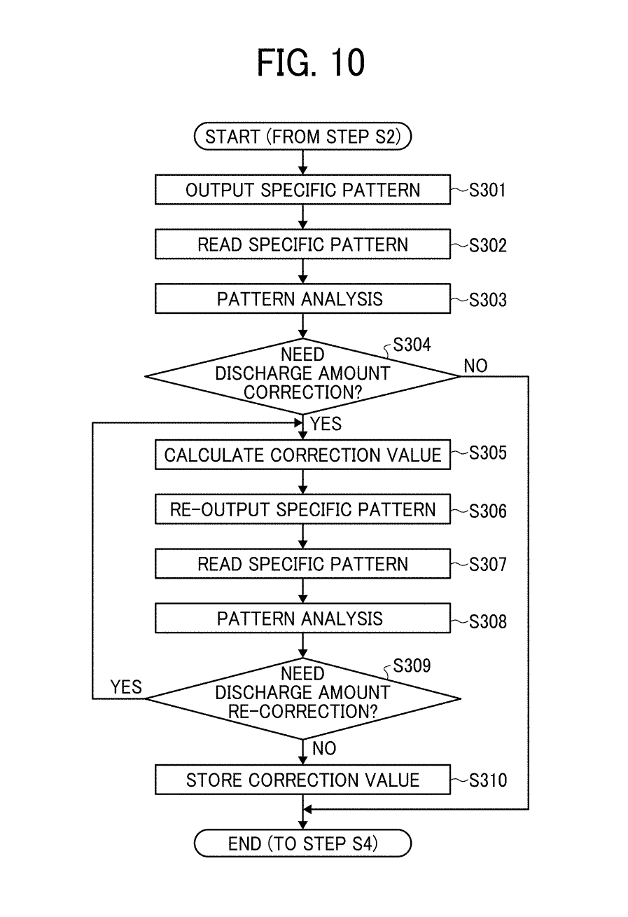

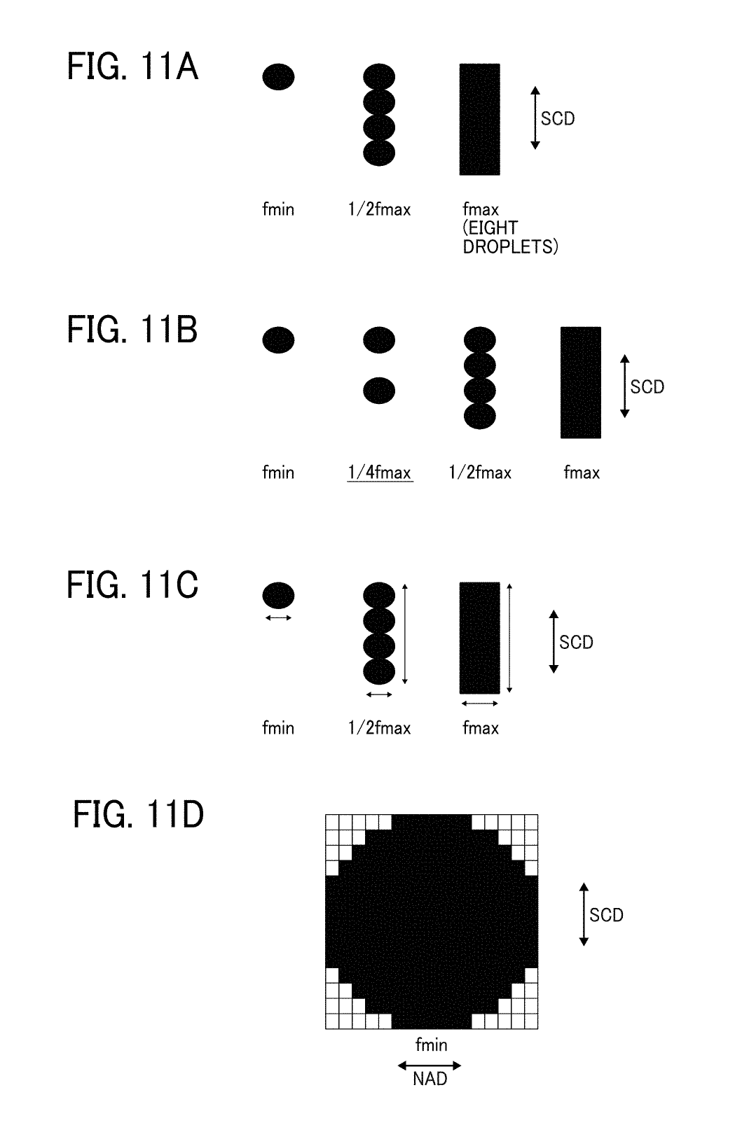

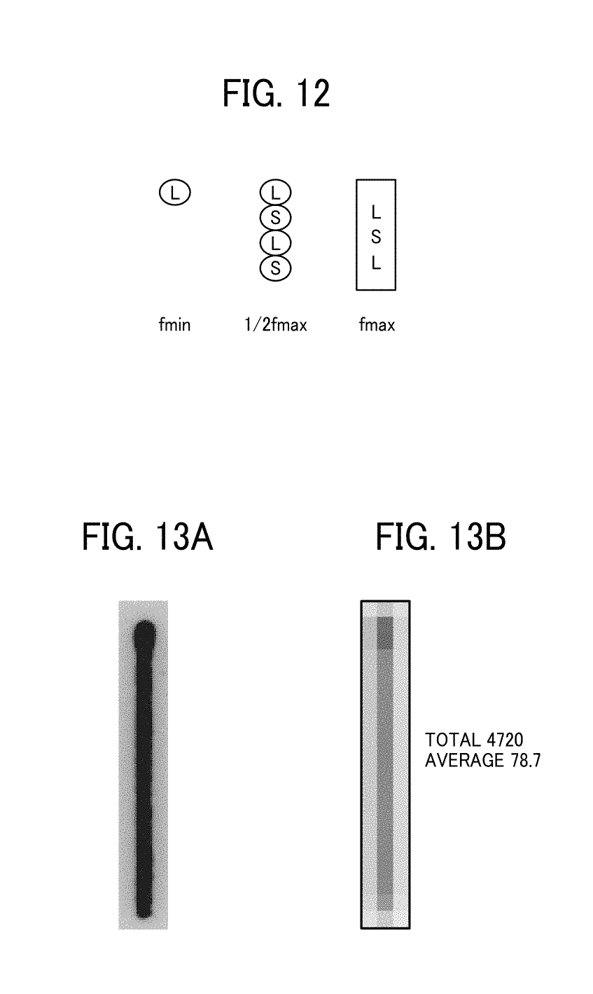

In the following, with reference to FIGS. 10 through 12, a description is provided of a discharge-discharge amount correction executed in step S3 in FIG. 5 as an example of the first embodiment. FIG. 10 is a flowchart of the discharge amount correction between the heads or between the nozzle arrays in the head according to the first embodiment when the scanner 140 is a high-resolution scanner. FIGS. 11A through 11D illustrate specific dot patterns formed by one type of droplet size used for the inspection made in the process flow in FIG. 10. FIG. 12 illustrate specific dot patterns formed by plurality types of droplet size used for the inspection made in the work flow in FIG. 10.

S301 in FIG. 10, a dot-shaped or line-shaped specific pattern is output with a plurality of magnification levels of the discharge amount.

For example, in order to examine the specific pattern (block of pattern), one of the heads intentionally outputs the liquid droplets with a plurality of standards (for example, ±0%, −5%, and −10%) in a direction to lower the magnification level with respect to a set value of each of the drive waveform without changing the droplet size of the discharge object.

For example, the image data used in the inspection is stored in the inspection image storage 45. Then, the drive waveform generator 61 acquires the image data information, generates the drive waveform using the acquired image data information, and outputs the generated drive waveform to the head driver 126. Thereby, the heads H1 to H7 discharges the ink droplets to output a pattern on the medium P.

A specific pattern used for the inspection made in the step S301 with reference to FIGS. 11 and 12. FIG. 11A illustrate arrayed patterns formed by an identical droplet size. FIG. 12 illustrates arrayed patterns in which droplets of different droplet sizes (large (L) and small (S)) are mixed.

Each of the specific pattern (specific pattern) made at the step S301 is formed by discharging the liquid droplet from one nozzle 122. Then, at least the arrayed pattern having identical droplet size (dot size) is formed as illustrated in FIG. 11A.

The arrayed pattern as illustrated in FIG. 11 extends in a sheet conveyance direction (SCD). For example, the identical (same) droplet size indicates that each of the droplets have one same droplet size of one of a large droplet size, a middle droplet size, or a small droplet size.

In FIGS. 11A through 11D, an example is illustrated to discharge the ink droplets for eight times in eight cycles. The left-hand pattern (fmin) in FIG. 11A is an example in which the ink droplet is discharged for one time in eight cycles. The central pattern (½fmax) in FIG. 11A is an example in which the ink droplet is discharged for four times in eight cycles. The right-hand pattern (fmax) in FIG. 11A is an example in which the ink droplet is discharged for eight times in eight cycles. In FIGS. 11A trough 11D, a vertical direction is a sheet conveyance direction (SCD). An example is illustrated in which ink droplet is discharged from the specific one nozzle for an inspection.

As illustrated in right-hand end of FIGS. 11A and 11B, when the large droplets are discharged with a pattern of “fmax (discharge ink droplets for eight times in eight cycles)”, the arrayed pattern forms a filled pattern.

Here, even when the identical size of ink droplets (for example, large droplets) are discharged, the droplet speed of a next-discharged ink droplet may be changed from the droplet speed of a previous-discharged ink droplet according to a time interval between the previous discharge and the next discharge. This change of the droplet speed is caused by the influence of fluctuation in a liquid surface (meniscus) in the nozzle 122 after the discharge process.

For example, when halftone is to be formed, ink droplets are discharged continuously depending on the density of the image. In order to discharge the ink droplets with an interval of one or plurality of spaces, the head controller 106 controls the discharge process for each specific pattern for each predetermined cycles (eight cycles in this example) in one nozzle that constitutes halftone. Each of the specific pattern formed by the droplets discharged from the nozzles 122 is inspected. For example, the specific pattern of one of fmin, ½fmax, or fmax as illustrated in FIG. 11A is regarded as one unit for the inspection.

Here, a plurality of specific patterns for combinations obtained by multiplying parameters of outputs and each droplet types (large, middle, and small) is made respect to one nozzle, respectively. For example, when the specific pattern of fmin is discharged plurality of times with the large droplets, the specific pattern of ½fmax is discharged plurality of times with the large droplets, and the specific pattern of fmax is discharged plurality of times with the large droplets, the measured result can be calculated by averaging the measured result. Thus, this embodiment can preferably decreases an error. The similar process is performed for the pattern made by the middle droplet and the small droplet.

In FIG. 11A, three types of the specific pattern in eight cycles are inspected. However, as illustrated in FIG. 11B, other specific patterns such as discharge two times in eight cycles (¼fmax) may be additionally inspected.

Further, as illustrated in FIG. 12, when the arrayed patterns (specific pattern) formed by mixing droplets of different droplet size is formed, the accuracy during making a halftone image can be increased.

The central pattern (½fmax) in FIG. 12 is an example in which the ink droplet is discharged for four times in eight cycles. The right-hand pattern (fmax) in FIG. 12 is an example in which the ink droplet is discharged for eight times in eight cycles. In the example of right-hand pattern (fmax) in FIG. 12, the head controller 106 controls the head H1 to H7 to sequentially and alternately discharge the ink droplets of large, small, large, and small droplet sizes in this order.

For example, when an intermediate color is expressed by halftone (halftone dots), the ink droplet is constituted by mixing a plurality of liquids according to density of the gradation of the image. Therefore, a pattern is made by intentionally mixing a plurality size of ink droplets (for example, more large droplets or more small droplets) as illustrated in FIG. 12. The discharge amount is corrected for each units of specific patterns so that the accuracy of the gradation adjustment can be improved before performing the process of the step S4 in FIG. 5.

In this case, also, a plurality of specific patterns for combinations between outputs and mixed patterns (droplets of large, small, large, and small size sequentially as illustrated in patterns of ½fmax and fmax in FIG. 12) is made respect to one nozzle of one head H1 to H7, respectively. When the specific pattern of ½fmax and fmax as illustrated in FIG. 12 is discharged plurality of times for each nozzles, the measured result can be calculated by averaging the measured result. Thus, this embodiment can preferably decreases an error.

In step S302, the scanner (reading device) 140 reads the specific pattern.

In the present embodiment, the resolution of the image scanned by the scanner 140 is higher than the resolution of the image formed by the ink droplets discharged by the heads H1 to H7. Thus, the scanner 140 can read each dots formed on the sheet P by discharging the ink droplets from each nozzles 122 of the heads H1 to H7.

Subsequently, the pattern is analyzed in the step S303 in FIG. 10. Specifically, in the step S302, the discharge amount calculator 42 calculates and compares the discharge amount according to the following procedure using the image (specific pattern) read by the scanner 140.

Here, following discharge amount is detected for each outputs because the magnification reference of a plurality of discharge amount is intentionally output for one specific pattern in the step S301.

(1) A value of a dot diameter (lateral arrow in ½fmax in FIG. 11C) or line width (lateral arrow in fmax in FIG. 11C) and a dot array length (vertical arrow ½fmax in FIG. 11C) or a line length (vertical arrow in fmax in FIG. 11C) for each heads is calculated to obtain an adhesion area of ink on the sheet P for each printing conditions.

Specifically, as illustrated in FIG. 11C, the dot diameter (arrows in lateral direction in FIG. 11C) and dot array length (arrows in vertical direction in FIG. 11C) for each patterns are measured. Then, an average value (AVG) is calculated for each specific patterns for each heads H1 to H7. For example, the lateral width of the arrow (dot diameter) of fmin and ½fmax in FIG. 11C becomes the dot diameter. However, the lateral width of the arrow of fmax in FIG. 11C becomes a line width because the specific pattern has a lined shape.

In this case, the measurement of the dot diameter and the dot array length (line width and line length in fmax) may be omitted by measuring only the dots discharged from the nozzles 122 at each ends of the heads H1 to H7. Here, the printed pattern formed by the ends of the heads H1 to H7 is a connection part with the pattern formed by the other heads H1 to H7. Thus, the measurement can be simplified by focusing the management on the ends of the heads H1 to H7.

Here, it is more desirable to calculate the dot diameter while adjusting a degree of eccentricity of the dots. It is possible to detect an existence of the satellite droplets as illustrated in FIG. 6 by calculating the degree of eccentricity. For example, it is determined that the satellite droplets is generated when the shape of the dot is distorted from a perfect circle (degree of eccentricity is high). In the present embodiment, when it is possible to measure the eccentricity by discharging an independent dot (fmin), the existence of the satellite droplets can be determined. Thus, the process of the satellite droplets adjustment in step S1 in the flowchart in FIG. 5 may be omitted.

FIG. 11C illustrates the example of measuring the area calculated by multiplying the vertical length (dot array length or line length) and the lateral width (dot width or line width). The dot width (dot size) or a dot array length and the line width and line length can be managed within the resolution of the scanner 140. The method of measuring the area is not limited to multiply the vertical length (dot array length or line length) and the lateral width (dot width or line width).

For example, when the resolution of the scanner 140 is sufficiently higher to the size of the discharged ink dot, the scanner 140 can read the dots for each read pixels of the scanner 140 as illustrated in an exploded view illustrated in FIG. 11D.

In FIG. 11D, it is determined that the dot is white or black in one pixel. However, when there is white part and colored part (black part, for example) mixed within one read pixel, the pixel having a pixel value of the image greater than a predetermined threshold value is counted as one pixel. For example, if an area of the black part in one read pixel is greater than the predetermined value, this pixel is counted as black pixel.

(2) The discharge amount (ink adhesion amount) of one droplet for each droplet types for each heads H1 to H7 is calculated using the measured value of each patterns.

Sheet information indicating a type of the sheet P as a recording medium is associated with an area of the specific pattern of the ink. Thereby, the discharge ink amount (adhesion ink amount) is estimated using the sheet information and the area of the specific pattern associated with each other. The discharge ink amount (adhesion ink amount) indicates a degree of adhesion of ink on the sheet P.

Specifically, the ink adhesion amount (ink discharge amount) (X pL (picoliter)) is computed based on the dot size on the sheet P and a penetration condition on the surface of the sheet P corresponding to a sheet condition, for example.

Tables 1A and 1B illustrates an equation for computing the ink adhesion area and the ink adhesion amount detected for the specific pattern.

TABLE 1A

| | H1 | H1 | H2 | H2 |
|---|---|---|---|---|
| | Large droplet | Small droplet | Large droplet | Small droplet |
| fmin | X11 | x11 | X21 | X21 |
| 1/2fmax | X12 | x12 | X22 | X22 |
| fmax | X13 | X13 | X23 | X23 |

TABLE 1B

| | H1 | H1 | H2 | H2 |
|---|---|---|---|---|
| | Large droplet | Small droplet | Large droplet | Small droplet |
| fmin | A11 | a11 | A21 | a21 |
| 1/2fmax | A12 | a12 | A22 | a22 |
| fmax | A13 | a13 | A23 | a23 |

Table 1A illustrates the ink adhesion area measured by scanning the dots and dot arrays (specific pattern) on the sheet P by the scanner 140. The unit of the ink adhesion area is μm² or pixels. Table 1B illustrates the ink discharge amount converted (calculated) from the ink adhesion area to the ink droplet amount. The unit of Table 1B is picoliters.

In an example as illustrated in Tables 1A and 1B, the specific pattern of fmin in top row in Tables 1A and 1B indicates an example of an independent dot formed by discharging the ink droplet one time in eight cycles as illustrated in the left-hand part of FIG. 11A. The central row of ½fmax in FIGS. 1A and 1B indicates an example of discharging the ink droplets four times in eight cycles as illustrated in the center of FIG. 11A. The bottom row of fmax in FIGS. 1A and 1B indicates an example of discharging the ink droplets eight times in eight cycles as illustrated in the right-hand part of FIG. 11A.

Here, the Tables 1A and 1B are illustrated by using schematic numeral such as X11 or A11. However, the specific converted value is different according to the types of the sheet P because a degree of penetration of ink and surface roughness of the sheet P are different according to the types of the sheet P. Thus, the size and shape of the ink droplet on the surface of the sheet P scanned by the scanner 140 becomes different according to the types of the sheet P. The scanned size and shape of the ink droplet influence the specific converted value. Therefore, the specific converted value of Table 1B (discharged ink amount (volume) or ink adhesion amount) converted from the measured ink adhesion amount in Table 1A is assumed to be set according to the types of the sheet P and is previously stored in the discharge amount calculator 42.

(3) The calculated discharge amounts are compared between the heads H1 to H7 and between nozzles 122 in the head.

The discharge amount calculator 42 calculates differences in the discharge amounts by comparing the ink adhesion amount (ink discharge amount) per specific pattern calculated in above described (2) between the heads H1 to H7 and between nozzles 122 in the head.

In the step S304, it is determined whether the density adjustment is necessary.

The discharge amount calculator 42 compares the differences in the ink discharge amount calculated in above-described (3) in the step S303 with the predetermined threshold value. When the difference is greater than the threshold value, the process goes to the step S305. When the difference is smaller than the threshold value, the process ends as the density correction is unnecessary.

In the step S305, the correction value of the drive waveform is calculated for each specific patterns if the density adjustment is necessary.

The initial-value magnification-setting section 66 corrects the droplet size of the droplet discharged from the head of greater discharge amount as an object of correction. The initial-value magnification-setting section 66 adjusts the droplet size of the head of the object so that the ink discharge amount of the object head to be match with the ink discharge amount of the head of smaller discharge amount. Thus, the discharge amount adjuster 142 corrects the drive waveform of a head of the plurality of heads H1 to H7 to be matched with the drive waveform of another head of the plurality of heads H1 to H7, which is smaller in the discharge amount than the head.

This correction process is executed according to the ink discharge amount for each heads H1 to H7 and the ink discharge amount from nozzles 122 for each droplet size as calculated above.

The present embodiment can control the generation of the satellite droplets and match the droplet size by reducing the magnification and correcting the drive waveform of the head of greater discharge amount so that the ink discharge amount matches with that of the head of smaller discharge amount.

The halftone information to be used for the correction is known beforehand. Thus, the constituent ratio of the droplets for each gradation (density parameter (%)) is known. For example, in one density parameter for one sheet type, the droplet types (sizes) and numbers of droplets (for example, large 50 droplets and small 100 droplets) is used within an image size of 256 by 256 pixels, for example. Further, the predetermined cycle, duty, and a discharging characteristic of the head is also known. The duty is discharge amount per predetermined cycle. Thus, the ratio of using the specific patterns of fmin (one dot/one cycle), ½fmax (four dots/one cycle), and fmax (eight dots/one cycle) as illustrated in FIG. 11A is known for each droplet types.

The droplet constituent can be specifically obtained by further analyzing the specific patterns contained in the halftone image based on the above-described information (droplet types, numbers of droplets, predetermined cycle, duty, discharge characteristic) as described in the example illustrated below.

In the following, a specific example of a correction value is illustrated in Tables 2A through 2C.

TABLE 2A

| Large droplet | Sum = 50 |
|---|---|
| fmin | 25 |
| 1/2fmax | 15 |
| fmax | 10 |

TABLE 2B

| Small droplet | Sum = 100 |
|---|---|
| fmin | 30 |
| 1/2fmax | 40 |
| fmax | 30 |

TABLE 2C

| | | Large droplet | | Small droplet |
|---|---|---|---|---|
| H1: | Ink adhering | A11*25 + A12*15 + | + | a11*30 + a12*40 + |
| | amount = | A13*10 | | a13*30 |
| H2: | Ink adhering | A21*25 + A22*15 + | + | a21*30 + a22*40 + |
| | amount = | A23*10 | | a23*30 |

By setting the correction value as illustrated in Tables 2A through 2C and measuring the specific pattern discharged from one nozzle, ink discharge amount can be adjusted for each plurality types of specific patterns. The plurality types of specific patterns constitute halftone pattern. Further, the specific patterns discharged from one nozzle can be adjusted respectively. Thus, the discharge amount can be corrected for each specific patterns within one head.

The trapezoid-shaped drive waveform as illustrated in FIG. 7 can be corrected to decrease a discharge speed and the discharge amount by reducing an amplitude Vpp of the drive waveform. Thus, the present embodiment can set the drive waveform according to the discharge amount (ink adhesion amount) by selecting the drive waveform according to the detected discharge amount from Table 3 as illustrated below.

TABLE 3

| Discharge amount | | |
|---|---|---|
| detection results per | | |
| specific patterns | Drive waveform | Remarks |
| Da (Small) | Va (Vpp Large) | Vpp = Referential value |
| Db (Middle) | Vb (Vpp Middle) | Vpp = Referential value × 0.9995 |
| Dc (Large) | Vc (Vpp Small) | Vpp = Referential value × 0.999 |

In Table 3, Da, Db, and Dc indicate the ink adhesion amount (ink discharge amount) per specific pattern. In case of independent droplet (fmin), Da, Db, and Dc indicate a size of one dot. Da is the smallest value, and Dc is the maximum value. Va, Vb, and Vc in Table 3 indicate drive waveform corresponding to the detected discharge amount. The drive waveform Va has the maximum voltage amplitude Vpp, and the drive waveform Vc has the minimum voltage amplitude Vpp. The drive waveform Vb has the medium voltage amplitude Vpp between the voltage amplitude Vpp of the drive waveform Va and Vc.

For the heads H1 to H7 and nozzles 122 that discharge large amount of ink (ink adhesion amount) per detected specific pattern, the discharge amount from the heads H1 to H7 and the nozzles 122 is reduced by reducing the voltage amplitude Vpp. Thus, the droplet size is equalized by matching (equalizing) the discharge amount of the heads H1 to H7 and nozzles 122 with other heads H1 to H7 and nozzles 122, the discharge amount of which are small.

The discharge amount adjuster 142 corrects the drive waveform to reduce differences in discharge amount of the droplets between the plurality of heads H1 to H7 according to the specific pattern read by the scanner 140. Preferably, the discharge amount adjuster 142 corrects the drive waveform to equalize the discharge amount of the droplets between the plurality of heads H1 to H7. Here, if the differences in discharge amount of the droplets between the plurality of heads H1 to H7 are within a predetermined range, the difference is considered to be equal to zero in the present embodiment.

In Table 3, an example of correcting the magnification of the amplitude of the drive waveform in three stages according to the discharge amount is illustrated. However, the number of stages in setting is not limited to three and may be other numbers.

The drive waveform to be set as illustrated in Table 3 is not limited to the specific pattern constituted by single droplet size. As illustrated in FIG. 12, it is preferable to previously set a specific pattern constituted by a plurality of droplet size (large and small, for example). For example, when variation of droplet size is occurred during continuous discharge or during predetermined cycle as illustrated in the center or right in FIG. 11A through 11C, the magnification of the amplitude may be adjusted only on the nozzles 122 on which the variation of droplet size is occurred.

The magnification of the drive waveform to be set for this kind of nozzles may be changed or unchanged depending on the types of specific patterns even when an identical droplet size is desired for both conditions of independent discharge and continuous discharge.

In Table 3, in order to equalize the droplet size, the magnification of the amplitude of the drive waveform is adjusted using the drive waveform of FIG. 7 as an example of correcting the drive waveform. However, the type of drive waveform itself may be changed using the drive waveform as illustrated in FIGS. 8A through 8C. For example, in case of Da (small discharge amount), the drive waveform of FIG. 8B is used to correct the drive waveform. In case of Db (medium discharge amount), the drive waveform of FIG. 8A is used to correct the drive waveform. In case of Dc (large discharge amount), the drive waveform of FIG. 8C is used to correct the drive waveform. Thereby, the discharge amount of droplet size that constitutes halftone can be corrected.

Further, the magnification correction as illustrated in Table 3 may be performed after performing the correction by selecting the drive waveform as illustrated in FIGS. 8A through 8C. The discharge amount can be finely set by combining a plurality of corrections. For example, there are three stages of adjusting the discharge amount in each correction processes using the correction of Table 3 and FIGS. 8A through 8C. However, six stages of discharge amount corrections become possible by combining the above-described corrections.

In the present embodiment, density unevenness for each of the nozzles 122 within the same head can be adjusted because the droplets can be inspected for each of the nozzles 122.

For example, when there is variation in nozzle diameter or nozzle height (length) because of the error during manufacture of the heads, the discharge amount from each nozzles 122 may be different even when an identical drive waveform is applied on piezoelectric elements corresponding to the nozzles 122 within identical head. In the discharge amount correction in the present embodiment, the discharge amount can be adjusted by decreasing the magnification of the amplitude of the drive waveform of the specific nozzle that discharge large ink amount (dense) to match with the nozzles 122 that discharge small ink amount (thin) in the identical head when the specific nozzle discharges larger amount of ink than other nozzles 122.

In step S306, the head controller 106 controls the heads H1 to H7 to discharge the ink droplets to re-output the specific pattern of each droplet types that reflects the correction value.

In step S307, the scanner 140 scans and reads the re-output specific pattern (specific pattern).

In step S308, the discharge amount calculator re-analyzes the specific pattern scanned by the scanner 140. The discharge amount calculator 42 calculates the discharge amount (ink adhering amount per specific pattern) according to the procedure as similar to the above-described steps of (1) through (3). The discharge amount calculator 42 compares the ink adhesion amount (ink discharge amount) per specific pattern between the heads H1 to H7 and between nozzles 122 in the head.

In the step S309, the discharge amount calculator 42 compares the differences in the adhesion amount per specific pattern between heads and between nozzles 122 with the predetermined threshold value. The discharge amount calculator 42 then determine a necessity of re-correction of the ink discharge amount.

In the step S310, the initial-value storage 68 stores the corrected value of the drive waveform of droplets for each specific patterns of the heads H1 to H7 when the re-correction of the discharge amount is determined to be not necessarily in the step S309.

The predetermined threshold value of the differences in the ink adhering amount in the steps S304 and S309 that determines the necessity of density adjustment is set to the value within an adjustment range of a target range (±2% of parameter, for example). The target range is a range in which the density difference between the heads H1 to H7 does not increase and a mixture ratio does not largely changes in the following gradation adjustment.

The first embodiment may be performed by combining with a third embodiment as described-below. When the first embodiment is combined with the third embodiment, it is preferable to set the initial value of the drive waveform to reduce the difference between the heads H1 to H7 in a pattern that is used to form an image having halftone density.

Here, halftone image is an image, the density of which is not 100% (black out or filled-in image). The density is determined by the types of medium such as sheet or film and drying condition. For example, the image is a halftone image in which blank and first color (black, cyan, magenta, and yellow) other than blank is mixed with predetermined ratio. The halftone image has a predetermine density.

The correction value of the magnification of the amplitude of the drive waveform set and stored as described-above is used in the gradation adjustment process as a next inspection operation and is also used for formation of the droplets in the printing operation after the inspection operation. The correction value corrects the density difference between the heads H1 to H7 and between the nozzles 122 in the head.

In this way, the present embodiment equalizes the discharge amount between the heads H1 to H7 and between the nozzles 122 in the head for each specific patterns by adjusting the magnification of the amplitude of the drive waveform. In the present embodiment, the number of droplets is not equalized, but the discharge amount from each nozzles 122 and from each heads is equalized. Thus, not only just after the inspection, but after when temperature changes over time, the present embodiment can prevent the generation of the density unevenness.

Therefore, the present embodiment can adjust the setting of the magnification for each detected specific patterns.

Discharge Amount Correction in a Second Embodiment (When the Scanner is a Low Resolution Scanner)

As described above, it is preferable to directly analyze the dot diameter from the image read by the scanner 140. However, if the resolution of the scanner 140 is lower than the recording (printing) resolution of the image formed by the heads H1 to H7, the scanner 140 cannot detect the droplet size of each droplets as illustrated in FIG. 13.

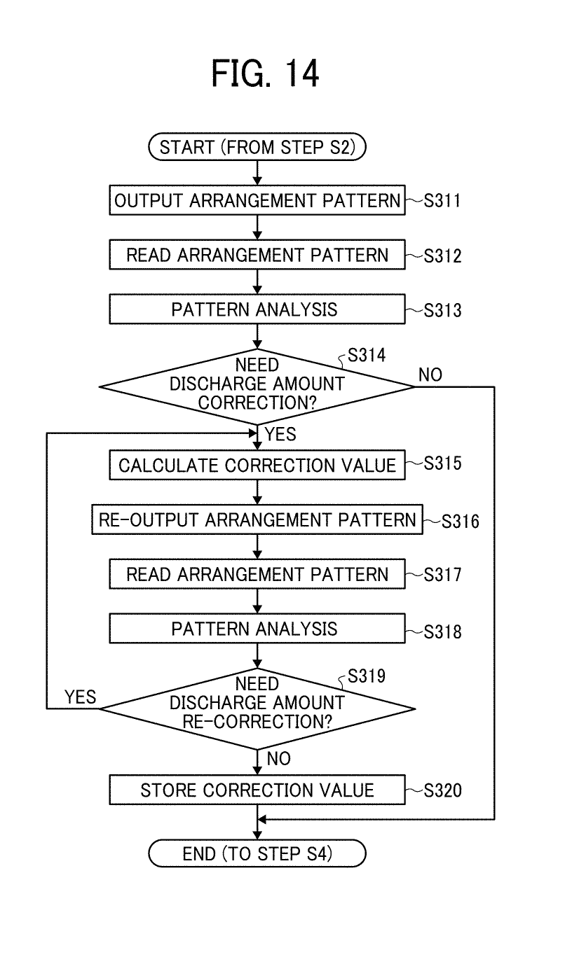

FIG. 13A illustrates an example of image formed on the sheet P. FIG. 13B illustrates an example of read image obtained by reading the image in FIG. 13A by the low resolution scanner 140. In FIG. 14, it is ideal to read the image as it is in FIG. 13A. However, if the resolution of the scanner 140 is lower than the recording (printing) resolution, the read image becomes the image as illustrated in FIG. 13B. Thus, it is difficult to correctly analyze the width and length of the specific pattern from the image. Further, even the image is analyzed by RGB (brightness of Red, Green, and Blue), it is difficult to detect width and length of the specific pattern because unevenness of the brightness is large.

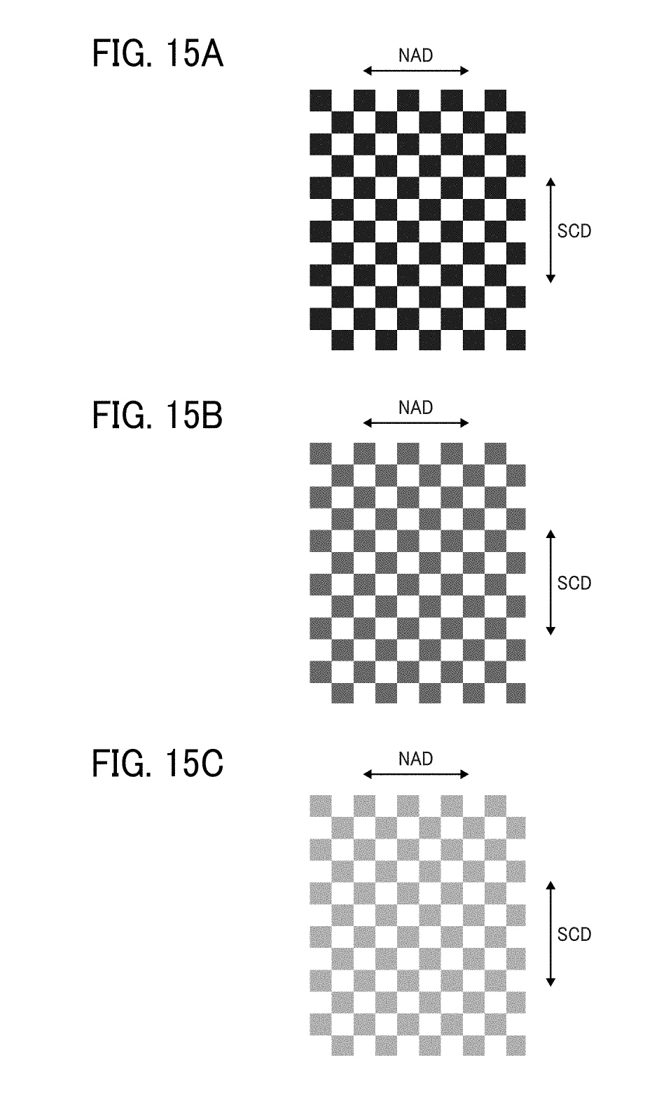

Therefore, when the resolution of the scanner is lower than the printing resolution and it is difficult to determine the individual dots or the specific pattern formed by the droplets discharged from one nozzle, the head controller 106 controls the heads H1 to H7 to form a staggered pattern as illustrated in FIGS. 15A through 15C and does not form arrayed pattern as in FIGS. 11A through 11C. The scanner 140 detects the density (density of black color, for example) within an area of the staggered pattern.

In the following, with reference to FIGS. 14 through 17, a discharge amount correction executed in step S3 in FIG. 5 as an example of the second embodiment is described. FIG. 14 is a flowchart of a dot adjustment of each heads according to an embodiment of this disclosure.

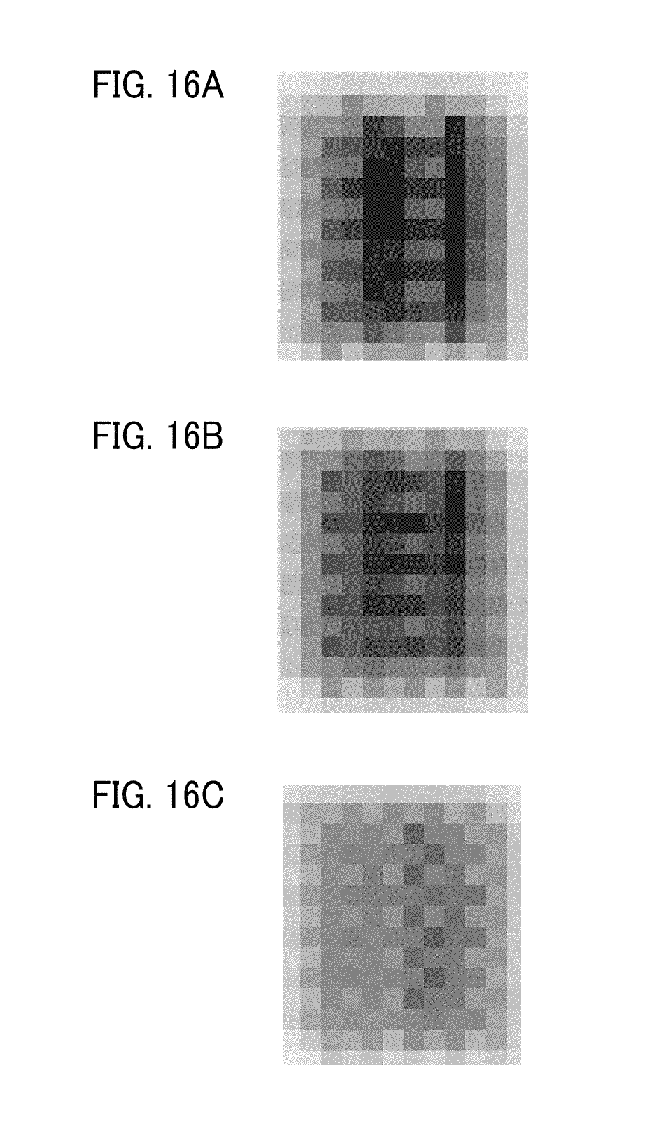

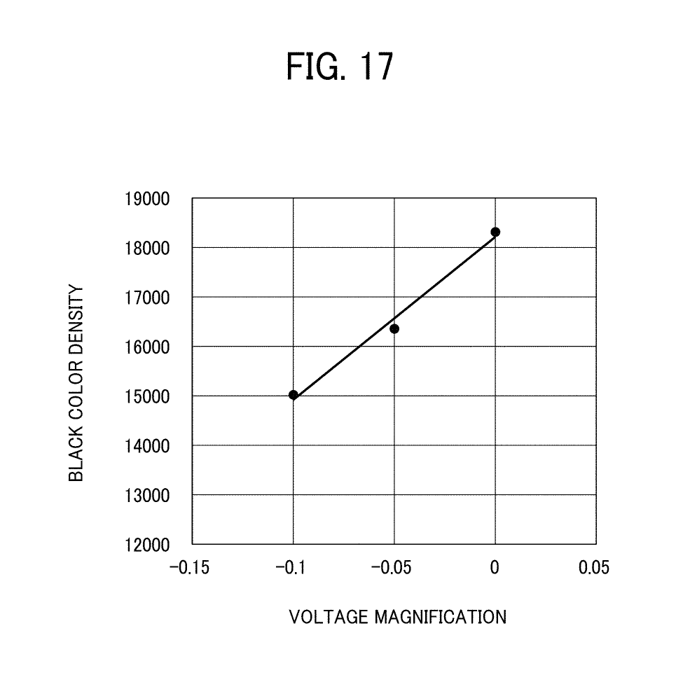

FIGS. 15A through 15C illustrate specific staggered arrangement patterns as an inspection chart in the present embodiment. FIGS. 16A through 16C illustrate an example of read image obtained by reading the staggered arrangement pattern in FIGS. 15A through 15C by the scanner 140. FIG. 17 is a graph that illustrates a relation between the black color density (density of black color, for example) and a voltage magnification. The scanner 140 detects the density per the area of the predetermined region (area of one black square region in the staggered arrangement pattern in FIG. 15A, for example).

In the step S311 in FIG. 14, the cyclic arrangement pattern including an identical specific pattern (arrangement pattern having predetermined area) is output with a magnification level for a plurality of discharge amount.

This cyclic arrangement pattern is a specific pattern used for the inspection. The cyclic arrangement pattern is an arrangement pattern having a predetermined region constituted by cyclic shapes formed by discharging droplets to form a specific pattern made of identical dots or identical lines. For example, the cyclic arrangement pattern is a staggered pattern as illustrated in FIG. 15.

In FIGS. 15A through 15C, ink droplets are discharged from the plurality of nozzles 22 onto the sheet P to form the arrangement pattern. The arrangement pattern is formed by densely arranged square shaped patterns arranged in staggered manner to have a predetermined region. Each of the square in FIGS. 15A through 15C is formed by the specific patterns as illustrated in FIGS. 11A through 11C or FIG. 12, for example.

In FIG. 14 and FIGS. 15A through 15C, the staggered arrangement pattern is described as an example. The arrangement pattern as the inspection chart applicable in the present embodiment has regular (cyclic) shaped region formed by the specific patterns of identical dots or identical lines as illustrated in FIGS. 11A through 11C by the droplets discharged from the adjacent plurality of nozzles 122.

It is preferable to previously perform the satellite droplet adjustment described in step S1 in FIG. 5 before executing the present embodiment.

When the pattern is output in step S311, it is preferable to output the arrangement pattern for inspection in the step S311 using the correction value on which the satellite droplets adjustment is performed. This correction value is stored in the reference value storage 67.

As illustrated in FIGS. 15A through 15C, the staggered arrangement pattern is formed (output) by fixing a specific pattern to be discharged per one nozzle. The discharge amount for each heads H1 to H7 and for each droplet types can be calculated even from the scanning result of the low resolution scanner 140.

As illustrated in FIGS. 15A through 15C, the present embodiment forms the staggered arrangement pattern constituted only by dots of an identical droplet size (dot size) as image data (inspection chart). For example, the identical (same) droplet size indicates that each of the droplets have one same droplet size of one of a large droplet size, a middle droplet size, or a small droplet size.

Here, FIGS. 15A through 15C illustrates staggered arrangement patterns. FIG. 15A is formed by a group of large sized droplets. FIG. 15B is formed by a group of middle sized droplets. FIG. 15A is formed by a group of small sized droplets. The number of droplets used for forming the specific pattern is identical.

The region of the individual square shaped region that are arranged in the staggered arrangement pattern manner as illustrated in FIGS. 15A through 15C is formed by groups of plurality of specific patterns.

Specifically, if the nozzles 122 have 1200 channels along the nozzle array direction (NAD). The number of channels corresponding to the number of nozzles 122. If the head H1 has 1200 channels, the number of nozzles in the head H1 is 1200. First, the specific image (one black square, for example) is formed by groups of the identical specific patterns (½fmax in FIG. 11, for example) constituted by droplets discharged from the adjacent nozzles 122 that corresponds to a plurality of adjacent channels (first to ten channels (nozzles), for example).

The staggered pattern is formed by black and blank (white) squares in FIGS. 15A through 15C formed by groups of specific patterns such as ½fmax in FIG. 11, for example. In case of forming the staggered arrangement pattern illustrated in FIGS. 15A through 15C, the nozzles 122 of one hundred channels (nozzles) can be inspected by repeating a discharging operation and a stopping operation from the nozzles 122 of ten channels×ten sets (total 100 channels in nozzle array direction (NAD)) for six times in the sheet conveyance direction (SCD).

Thus, there are ten black and blank squares in lateral direction and twelve black and blank squares in vertical direction (SCD) in FIGS. 15A through 15C. Here, the head has 1200 channels in the nozzle array direction (NAD, lateral direction) and 100 channels within 1200 channels are used for outputs the staggered arrangement pattern as an inspection chart.

By detecting the staggered arrangement pattern of ten channels×ten sets, not only the variation of discharge amount between the heads H1 to H7, but also the comparison of the variation of discharge amount between the nozzles 122 in one head is possible. For example, the staggered arrangement pattern formed by first to 100 channels and the staggered arrangement pattern formed by 1100 to 1200 channels are compared. Then, the discharge amount is adjusted to match with the staggered arrangement pattern having thinner density (smaller discharge amount) for each staggered arrangement patterns (for every 100 channels, for example).

The number of channels (nozzles) that forms the staggered arrangement pattern is appropriately changeable according to the resolution of the scanner 140.

For example, as another example, the region of the individual square shaped region that are arranged in staggered manner as illustrated in FIGS. 15A through 15C may be formed by one dot discharged from one nozzle. In this case, the specific pattern (fmax in FIG. 11A, for example) is formed by the droplets discharged from first channel (leftist nozzle) to form one black square region located in the top leftist part in FIG. 15A. Further, the specific pattern identical to the first channel (fmax in FIG. 11A, for example) is formed by the droplets discharged from the second channel arranged next to the first channel by shifting the discharge timing for eight cycles from the first channel.

The staggered arrangement pattern of black and blank (white) is made according to the existence of the specific pattern formed by this method. For example, the staggered arrangement pattern as illustrated in FIGS. 15A through 15C is formed (output) by repeating discharging process and stopping process from nozzles 122 of 1 channel×10 sets (total 10 channels) for six times in the sheet conveyance direction (SCD). Thus, 10 channels of nozzles 122 can be inspected.

By detecting the staggered arrangement pattern for 1 ch×10 sets, not only the variation of discharge amount between the heads H1 to H7 but also the variation of discharge amount between the nozzles 122 in one head can be compared (detected). For example, the staggered arrangement pattern formed by one to ten channels and the staggered arrangement pattern formed by 11 to 20 channels are compared.

Then, the discharge amount is adjusted to match (equalize) with the staggered arrangement pattern having thinner density (discharge amount) for each staggered arrangement patterns (for every ten channels, for example).

In FIGS. 15A through 15C, the number of dots in each square is identical. However, the droplet size of the droplets that forms the patterns in In FIGS. 15A through 15C is different respectively.

The patterns (staggered patterns) in FIGS. 15A through 15C and FIGS. 16A through 16C illustrates an example in which a ratio between the blank (white) background and black background is uniform. However, the ratio between the blank (white) background and black background may be changed if the specific pattern of identical dots or lines is formed by the droplets discharged from the plurality of nozzles that constitutes a predetermined region and if the specific pattern is cyclic.

In the present embodiment, a plurality of specific patterns is formed plurality of times by the sets of outputs by each droplet types (large, middle, and small) for one head in the predetermined area. Thus, all the shape of the black background parts that constitutes the predetermined pattern becomes identical, and the measured (detected) results can be averaged and calculated. Therefore, the present embodiment can reduce detection error.

For example, in FIG. 15A, the example of forming the specific pattern of ½fmax in FIG. 11A with droplets discharged from the adjacent plurality of nozzles 122 is described. However, the specific pattern of fmin or ¼fmax in FIG. 11B may be formed by discharging droplets from the nozzles 122, and this specific pattern may be inspected to detect the variation of density between the nozzles 122. In this case, the visual density looks thinner than the density in FIG. 15A even when the specific pattern is formed using the large droplets.

To form halftone image, the staggered arrangement pattern as illustrated in FIGS. 15A through 15C is formed by following procedure. First, square shaped dots are formed by discharging droplets from the nozzles 122. Each of square shaped dots is formed by groups of the specific patterns as illustrated in FIG. 11A through 11C or FIG. 12. The square shaped dots may be formed by combination of plurality types of the specific patterns.

This combination of the specific patterns having types according to multiple of outputs and mixture pattern (large, small, large, and small, in a sequential order as illustrated in the center of FIG. 12, for example). A plurality of the combination of square shaped dots of identical type is arranged plurality of times to form the staggered arrangement pattern as illustrated in FIGS. 15A through 15C. That is, the content inside the square shaped dot is the mixture of specific patterns in FIGS. 11A through 11C or FIG. 12. However, the staggered arrangement pattern may be formed by arranging plurality of mixture of specific patterns, the mixture ratio of droplets of which is identical to the mixture ratio in other square shaped dots.

The above-described combination is formed by printing with the drive waveform, the magnification of the amplitude of which is corrected, for at least three levels. The combination is inspected to improve the accuracy of density during applying the present embodiment to the intermediate color that uses halftone.

In step S312, the scanner 140 scans and reads the cyclic arrangement pattern formed on the sheet P.

In the present embodiment, the read image scanned and read by the scanner 140 looks blurry as illustrated in FIGS. 16 through 16C even the image data is formed as illustrated in FIGS. 15A through 15C because the resolution of the scanner 140 is low.

In the step S313, the discharge amount calculator 42 analyzes the pattern based on the image scanned by the scanner 140.

(1) A total value of the black is calculated for the image that is a group of formed dots for each printing conditions. That is, a total of density of color (density per area of predetermined region) is calculated for the arrangement pattern having a predetermined region. For example, a total of black density is calculated when the black ink is used. As illustrated in FIG. 17, the detected density and the voltage magnification relative to the present drive waveform can be associated.

When the density of one head is large (right-hand side in FIG. 7), the density of one head may be larger than the other heads. Thus, the one head has higher possibility to become an object of discharge amount correction.

(2) A correlation graph between density and a voltage magnification is made.

As illustrated in FIG. 17, the detected density and the voltage magnification relative to the present drive waveform can be associated. When the density of one head is large (right-hand side in FIG. 7), the density of one head may be larger than the other heads. Thus, the one head has higher possibility to become an object of discharge amount correction.

The ratio of white background may be changed when it is difficult to compare the density in FIG. 17.

(3) The density for each arrangement patterns calculated between the heads H1 to H7 is compared between heads. In the correlation as illustrated in FIG. 17, when the density is large (right-hand side in FIG. 17), this head has higher possibility to become an object of discharge amount correction because the density of this head is larger than the density of other heads.

In the step S304, it is determined whether the discharge amount correction is necessary.

The discharge amount calculator 42 compares the density of the arrangement pattern having an identical droplet constituent calculated in above described (3) in the step S313. If the differences in the density between the heads H1 to H7 is greater than the predetermined threshold value, the process goes to the step S315. When the difference is smaller than the threshold value, the process ends as the density correction is unnecessary.

In the step S315, the discharge amount calculator 42 calculates the correction value of the drive waveform for each specific patterns if the discharge amount calculator 42 determines that the discharge amount correction is necessary. The initial-value magnification-setting section 66 corrects the magnification of the amplitude of the drive waveform (droplet size) on the head, the discharge amount of which is large. The correction is made such that the ink discharge amount (density per predetermined area) of the head of large discharge amount becomes substantially equal to the ink discharge amount of the head of smaller discharge amount. This correction process is executed according to the ink discharge amount for each heads H1 to H7 and the ink discharge amount from nozzles 122 for each droplet size as calculated above.

The present embodiment can equalize the discharge amount (droplet size) by reducing the magnification of amplitude of the drive waveform of the head of large discharge amount to be equal to that of the head of smaller discharge amount. Thus, the present embodiment can equalize the discharge amount (droplet size) while controlling the generation of the satellite droplets and

[symbol]

In the present embodiment, the correction value is calculated for each of the specific patterns in FIG. 11A through 11C that forms the square regions in the staggered arrangement pattern in FIGS. 15A through 15C.

The trapezoid-shaped drive waveform as illustrated in FIG. 7 can be corrected to decrease a discharge amount by reducing an amplitude Vpp of the drive waveform. Thus, the present embodiment can set the drive waveform according to the discharge amount (density) by selecting the drive waveform from Table 4 according to the detected density in the arrangement pattern.

TABLE 4

| Density detection | | |
|---|---|---|
| results per | | |
| arrangement | | |
| patterns | Drive waveform | Remarks |
| Sa (Low) | Va (Vpp Large) | Vpp = Referential value |
| Sb (Middle) | Vb (Vpp Middle) | Vpp = Referential value × 0.9995 |
| Sc (High) | Vc (Vpp Small) | Vpp = Referential value × 0.999 |

In Table 4, Sa, Sb, and Sc indicate the density of colors (discharge amount) per staggered arrangement patterns or per specific patterns. Sa is the smallest value, and Sc is the maximum value. Va, Vb, and Vc in Table 4 indicate drive waveform corresponding to the detected discharge amount. The drive waveform Va has the maximum voltage amplitude Vpp, and the drive waveform Vc has the minimum voltage amplitude Vpp. The drive waveform Vb has the medium voltage amplitude Vpp between the voltage amplitude Vpp of the drive waveform Va and Vc.

For the heads H1 to H7 and nozzles 122 that discharge large amount of ink per detected specific pattern, the discharge amount from the heads H1 to H7 and the nozzles 122 is reduced by reducing the voltage amplitude Vpp. Thus, the discharge amount (droplet size) of the heads H1 to H7 and nozzles 122 of large discharge amount is equalized to the discharge amount (droplet size) of the heads H1 to H7 and nozzles 122 of small discharge amount.

In Table 4, an example of correcting the magnification of the amplitude of the drive waveform in three stages according to the discharge amount (density) is illustrated. However, the number of stages in setting is not limited to three and may be other numbers.

In Table 4, in order to equalize the discharge amount (droplet size), the magnification of the amplitude of the drive waveform is corrected using the drive waveform of FIG. 7 as an example. However, the type of drive waveform itself may be changed using the drive waveform as illustrated in FIGS. 8A through 8C. For example, in case of Sa (small discharge amount), the drive waveform of FIG. 8B is used to correct the drive waveform. In case of Sb (medium discharge amount), the drive waveform of FIG. 8A is used to correct the drive waveform. In case of Sc (large discharge amount), the drive waveform of FIG. 8C is used to correct the drive waveform. Thereby, the discharge amount can be corrected for each specific patterns.

Further, the magnification correction as illustrated in Table 4 may be performed after performing the correction by selecting the drive waveform as illustrated in FIGS. 8A through 8C. The discharge amount can be finely set by combining a plurality of corrections.

In step S316, the head controller 106 controls the heads H1 to H7 to discharge the ink droplets to re-output (re-print out) the arrangement pattern with further finer magnification levels that reflects the correction value.

In step S317, the scanner 140 scans and reads the re-output specific pattern.

In step S318, the discharge amount calculator 42 re-analyzes the specific pattern and arrangement pattern scanned by the scanner 140. The discharge amount calculator 42 calculates the discharge amount (density per predetermined area of the arrangement pattern) according to the procedure as similar to the above-described steps S303 of (1) through (3). The discharge amount calculator 42 compares the ink discharge amount between the heads H1 to H7 and between nozzles 122 in the head.

In the step S319, the discharge amount calculator 42 compares the differences in the discharge amount per specific pattern between heads H1 to H7 and between nozzles 122 with the predetermined threshold value. The discharge amount calculator 42 then determines a necessity of re-correction of the discharge amount.

In the step S320, the initial-value storage 68 stores the corrected value of the drive waveform for each specific patterns (for each square region in FIG. 15A, for example) of the heads H1 to H7 when the re-correction of the discharge amount is determined to be not necessarily in the step S319.

The predetermined threshold value of the differences in the ink discharge amount (density) in the steps S314 and S319 that determines the necessity of discharge amount correction is set to the value within an correction range of a target range (within ±2% of density parameter, for example). The target range is a range in which the density difference between the heads H1 to H7 does not increase and a mixture ratio does not largely changes in the following gradation adjustment.

When the first embodiment is combined with the third embodiment, it is preferable to set the initial value of the drive waveform to reduce the difference between the heads H1 to H7 in a pattern that is used to form an image having halftone density.

In this way, the present embodiment equalizes the discharge amount between the heads H1 to H7 and between the nozzles 122 in the head for each droplet size by adjusting the magnification of the amplitude of the drive waveform. In the present embodiment, the discharge amount from each nozzles 122 and from each heads H1 to H7 is equalized. Thus, not only just after the inspection, but also after when temperature changes over time, the present embodiment can prevent the generation of the density unevenness.

Third Discharge Amount Correction in the Third Embodiment

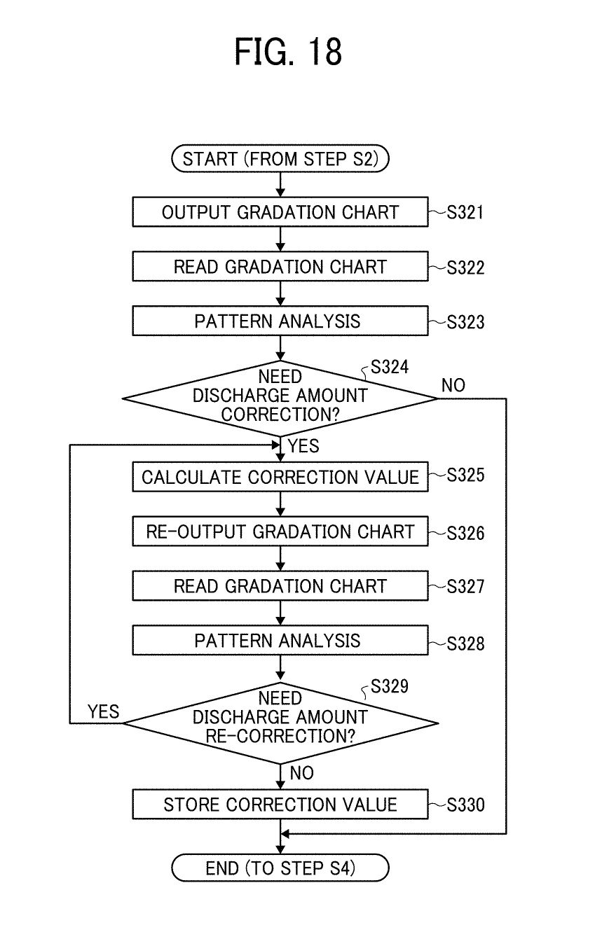

In the following, with reference to FIGS. 18 through 21, a discharge amount correction executed in step S3 in FIG. 5 as an example of the third embodiment is described.

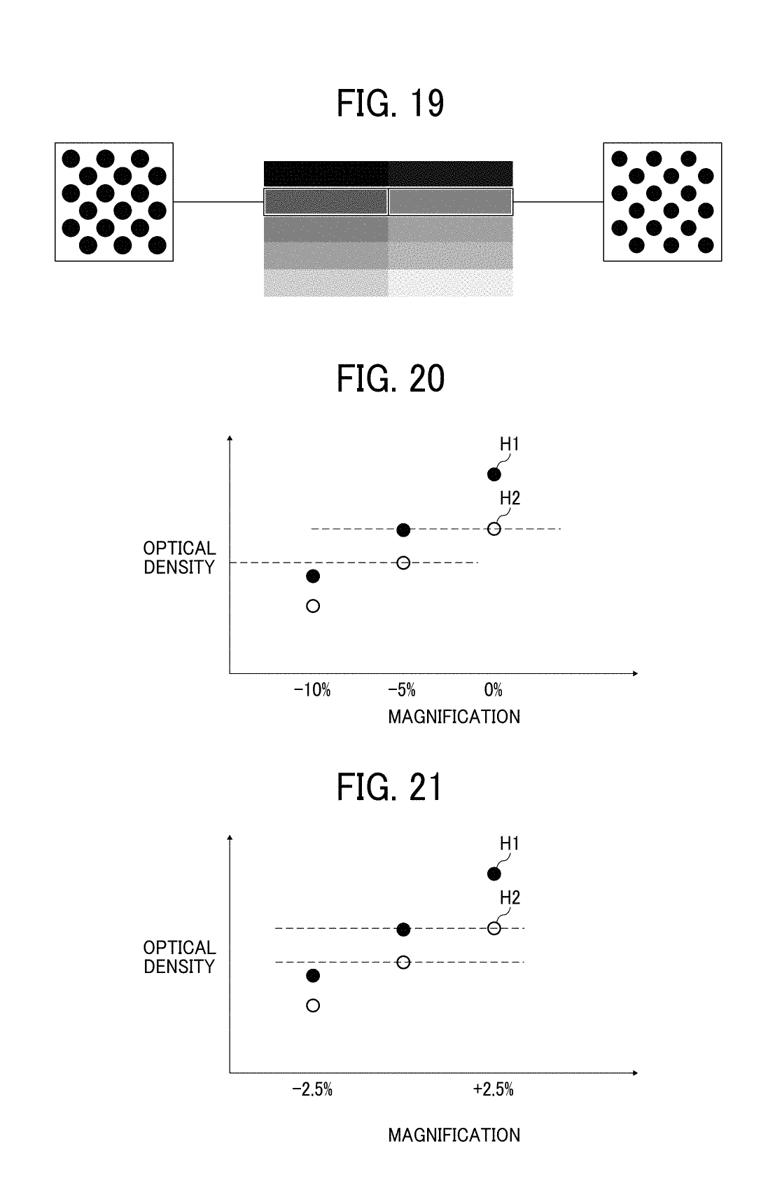

FIG. 18 is a flowchart of a gradation adjustment according to an embodiment of the present disclosure. FIG. 19 illustrates an example of a gradation chart including plurality of halftone images detected by the present embodiment. FIG. 20 is a correlation graph between density and a voltage magnification. FIG. 21 is a correlation graph between density and a voltage magnification with magnification setting finer than the magnification of FIG. 20. With reference to FIG. 18 through 21, a flow of gradation adjustment is described below.

In the step S321, a gradation chart is output. The gradation chart includes the plurality of halftone images corresponding to plurality of predetermined density parameter, respectively. Specifically, the gradation chart having the plurality of halftone images is output with a plurality of magnification levels of the discharge amount.

FIG. 19 illustrate a gradation chart in which columns of the halftone images in the gradation chart are filled by the density in fifth steps of 20%, 40%, 60%, 80%, and 100% from the bottom to top in case the black (K) is used as a color, for example.

In order to examine the density unevenness and an adjustment example, the gradation chart is intentionally output for plurality of standards (for example, ±0%, −5%, and −10%) in a direction to lower the magnification level with respect to a set value of each of the drive waveform without changing the mixture ratio of the droplet size that is a parameter for constituting one density in one head.

In FIG. 19, the density is changed while identical density is set for each of heads H1 to H7. When the head H1 in left and the head H2 in right are compared, there is density unevenness between two heads H1 and H2. The dot size per area of the heads H1 and H2 is different. For example, the dot size in left (head H1) is larger than the dot size in right (head H2. This difference is occurred by the change in the nozzle diameter (nozzle size) owing to the manufacturing error that causes the slight difference (unevenness) in the dot size for each heads.

In step S322, the scanner 140 scans and reads the halftone images in the gradation chart.

Here, the discharge amount correction using the gradation chart (halftone image) in the present embodiment calculates the density. Thus, any one of the high resolution scanner 140 or low resolution scanner 140 may be used.

In the step S323, the discharge amount calculator 42 analyzes the pattern based on the gradation chart (halftone images) scanned by the scanner 140.

(1) An optical density is detected. In the step S321, an optical density is detected for each of the output gradation chart (halftone images) because the gradation chart for one density parameter is intentionally output by correcting the amplitude of the drive waveform.

(2) A correlation graph between density and a voltage magnification is made. FIG. 20 is a correlation graph between density and a voltage magnification. In the example in FIG. 20, the density detected on the head H1 is greater than the density detected on the head H2. Further, a transition of the optical density when the magnification of the amplitude of the waveform output in the step S321 is corrected on the present optical density of the gradation chart (halftone image) is also illustrated in the same correlation graph in FIG. 20

(3) The optical density is compared between the heads H1 to H7 using the correlation graph.

The correlation graph in FIG. 20 also illustrates the transition of the optical density when the magnification is corrected. It is understood from FIG. 20 that if the amplitude of the drive waveform of head H1 is set to −5%, the optical density of head H1 becomes identical to the optical density of head H2.

In the step S324, it is determined whether the discharge amount correction is necessary.

In the step S325, the discharge amount calculator 42 calculates the correction value of the drive waveform for the droplet size that constitutes the gradation chart (halftone images) if the discharge amount calculator 42 determines that the discharge amount correction is necessary. For example, if there is density difference as illustrated in FIG. 20, the discharge amount correction becomes necessary.

The initial-value magnification-setting section 66 adjusts the droplet size of the droplet discharged from the head of greater discharge amount as an object of correction. The initial-value magnification-setting section 66 adjusts the droplet size of the head of the object so that the ink discharge amount of the object head to be match with the ink discharge amount of the head of smaller discharge amount. This correction process is executed according to the ink discharge amount for each heads H1 to H7 and the ink discharge amount from nozzles 122 for each droplet size as calculated above.

The present embodiment can control the generation of the satellite droplets while equalize the droplet size by reducing the magnification of the amplitude of the drive waveform of the head of greater discharge amount so that the optical density of the head of the large discharge amount to be matched with the optical density of the head of smaller discharge amount.

In the present embodiment, the correction value is calculated for whole of the halftone pattern (gradation chart) as a single unit.

The trapezoid-shaped drive waveform as illustrated in FIG. 7 can be corrected to decrease a discharge amount by reducing an amplitude Vpp of the drive waveform. Thus, the present embodiment can set the drive waveform according to the optical density by selecting the drive waveform from Table 5 according to the optical density detected for each gradation chart (halftone pattern) of the specific density parameter (%) as described in Table 5 illustrated below.

TABLE 5

| Optical density | | |
|---|---|---|
| detection results | | |
| per halftone | | |
| patterns | Drive waveform | Remarks |
| ODa (Low) | Va (Vpp Large) | Vpp = Referential value |
| ODb (Middle) | Vb (Vpp Middle) | Vpp = Referential value × 0.9995 |
| ODc (High) | Vc (Vpp Small) | Vpp = Referential value × 0.999 |

In Table 5, ODa, ODb, and ODc are optical density detected for each gradation charts (halftone image) of the predetermined density parameters (%). Va, Vb, and Vc in Table 4 indicate drive waveform corresponding to the detected discharge amount. The drive waveform Va has the maximum voltage amplitude Vpp, and the drive waveform Vc has the minimum voltage amplitude Vpp. The drive waveform Vb has the medium voltage amplitude Vpp between the voltage amplitude Vpp of the drive waveform Va and Vc.

As the optical density detected for each halftone image becomes denser, the discharge amount from the heads H1 to H7 is further reduced by further reducing the voltage amplitude Vpp. Thus, the discharge amount (droplet size) of the heads H1 to H7 and nozzles 122 of large discharge amount is equalized with the discharge amount (droplet size) of the heads H1 to H7 and nozzles 122 of small discharge amount.

In Table 5, an example of correcting the magnification of the amplitude of the drive waveform in three stages according to the optical density is illustrated. However, the number of stages in setting is not limited to three and may be other numbers such as four stages.

In this case, the plurality of droplets that constitutes the gradation chart (halftone image) is uniformly corrected with the magnification as illustrated in Table 5.

In Table 5, in order to equalize the discharge amount (droplet size), the magnification of the amplitude of the drive waveform is corrected using the drive waveform of FIG. 7 as an example. However, the type of drive waveform itself may be changed using the drive waveform as illustrated in FIGS. 8A through 8C. In case of ODa (small optical density), the drive waveform of FIG. 8B is used to correct the drive waveform. In case of ODb (medium optical density), the drive waveform of FIG. 8A is used to correct the drive waveform. In case of ODc (large optical density), the drive waveform of FIG. 8C is used to correct the drive waveform. Thereby, the discharge amount can be corrected for each of the gradation charts (halftone image).

Further, the magnification correction as illustrated in Table 5 may be performed after performing the correction by selecting the drive waveform as illustrated in FIGS. 8A through 8C. The discharge amount can be finely set by combining a plurality of corrections.

In step S326, the head controller 106 controls the heads H1 to H7 to discharge the ink droplets to re-output the gradation chart (halftone image) of the specific density parameters (gradation, (%)) that reflects the correction value. Specifically, the head controller 106 controls the heads H1 to H7 to re-output (re-print out) the gradation chart (halftone image) with further finer magnification levels that reflects the correction value.

In order to examine the density unevenness and an adjustment example, the gradation chart is intentionally output for plurality of standards in a direction to lower the magnification level with respect to a set value of each of the drive waveform without changing the mixture ratio of the droplet size that is a parameter for constituting one density in one head. At this time, the values around the corrected value are output. For example, the voltage magnification of −5% is used as a tentative value from the correlation graph of FIG. 20,

In step S327, the discharge amount calculator 42 re-analyzes the gradation chart (halftone image) scanned by the scanner 140. As similar to the step S323, (1) the optical density is detected, (2) the correlation graph between the optical density and the voltage magnification is made, and (3) the optical density is compared using the correlation graph.

In this case, the gradation chart is output with finer changes in the magnification of the amplitude in the step S236 as illustrated in FIG. 21, the correction value may be examined using the correlation graph, the voltage magnification of which is finer than the correlation graph in FIG. 20.

In the step S329, the discharge amount calculator 42 compares the differences in the discharge amount per the gradation chart (halftone image) between heads H1 to H7 and between nozzles 122 in the head with the predetermined threshold value. The discharge amount calculator 42 then determines a necessity of re-correction of the discharge amount.

In the step S330, the initial-value storage 68 stores the corrected value of the drive waveform for each droplets that constitutes the gradation chart (halftone image) of the heads H1 to H7 (for each groups of entire nozzles that constitutes the halftone image) when the re-correction of the discharge amount is determined to be not necessarily in the step S329.

The predetermined threshold value of the differences in the optical density in the steps S324 and S329 that determines the necessity of discharge amount correction is set to the value within an correction range of a target range (within ±2% of density parameter, for example). The target range is a range in which the differences in optical density between the heads H1 to H7 do not increase and a mixture ratio does not largely changes in the following gradation adjustment.

It is preferable to set the initial value of the drive waveform to reduce the difference in the optical density between the heads H1 to H7 in a pattern that is used to form an image having halftone density.

In this way, the present embodiment equalizes the discharge amount between the heads H1 to H7 and between the nozzles 122 in the head for each droplet size by adjusting the magnification of the amplitude of the drive waveform. In the present embodiment, the discharge amount from each nozzles 122 and from each heads H1 to H7 is equalized, and the number of the discharge droplets is not equalized. Thus, not only just after the inspection, but also after when temperature changes over time, the present embodiment can prevent the generation of the density unevenness.

The discharge amount correction in the above-described first to third embodiments can achieve the discharge amount correction by executing one of the following procedures.

The correction value of the magnification of the amplitude of the drive waveform set and stored in the discharge amount correction process in first through third embodiments are used in the gradation adjustment process as a next inspection operation. The correction value is used for correcting the discharge amount difference (optical density difference) between the heads H1 to H7 and between the nozzles 122 in the head. The correction value is also used for forming the image by discharging the droplets in the printing operation (production printing, for example) after the inspection operation.

Even when any one of the discharge amount correction in the first to third embodiments is executed, unevenness of the discharge amount between the heads H1 to H7 can be reduced because the dot size formed by the droplet to be discharged (droplet discharge amount) is corrected. Thus, even when the environment temperature changes, the discharge amount also changes similarly for entire heads. Therefore, unevenness of the discharge amount between the heads H1 to H7 can be reduced

Even when any one of the discharge amount correction in the first to third embodiments is executed, if halftone image formed by second color (Black, Yellow, Magenta, or Cyan, for example) is used at a later stage of the printing operation, the halftone image of second color is superimposed on the halftone image formed by the first color (Yellow, Magenta, or Cyan, other than first color) that is printed in the preceding stage of the printing operation. Thus, if there is an error such as density unevenness, the color (hue angle) may be changed and density difference may be emphasized. Therefore, it is preferable to adjust (correct) the discharge amount within the further reduced target range (density parameter of ±1%, for example).

The discharge amount correction in any one of first to third embodiments corrects the discharge amount for solving the unevenness of the density because of manufacturing error. Thus, the discharge amount correction is executed when an initial setting of the head is performed and when the head is exchanged.

The density unevenness occurred during long-term use of the printer is often caused by the nozzle clogging caused by viscosity rise. The head is recovered by a recovery operation such as wiping, suction, and flushing without adjusting the drive waveform for discharging droplets during image forming. If the head cannot be recovered by the recovering operation, the gradation adjustment is executed minimally.

Gradation Adjustment

The process of gradation adjustment executed in the step S4 in FIG. 5 is described in further detail below. The gradation adjustment changes the number of dots (droplets) by the discharge amount correction between the heads H1 to H7 to adjust halftone during constituting the intermediate color. In the gradation adjustment process, the density is adjusted by previously set the mixture ratio of droplet size as described in Table 6 illustrated below.

TABLE 6

| Gradation | Fixed value/mixture ratio |
|---|---|
| chart | Large droplet:middle droplet:small droplet:No discharge |
| 105% | P105/95:5:0:0 |
| 100% | P100/90:10:0:0 |
| 95% | P95/80:10:0:5 |
| . . . | . . . |
| 85% | P85/60:25:0:15 |
| 80% | P80/50:30:0:20 |
| 75% | P75/35:40:0:25 |
| . . . | . . . |
| 65% | P65/15:50:0:35 |
| 60% | P60/10:50:0:40 |
| 55% | P55/5:45:5:45 |
| . . . | . . . |
| 45% | P45/0:25:20:0 |
| 40% | P40/0:15:25:60 |
| 35% | P35/0:5:30:65 |
| . . . | . . . |
| 25% | P25/0:5:20:75 |
| 20% | P20/0:0:20:80 |
| 15% | P15/0:0:15:85 |
| . . . | . . . |
| 0% | P0/0:0:0:0 |

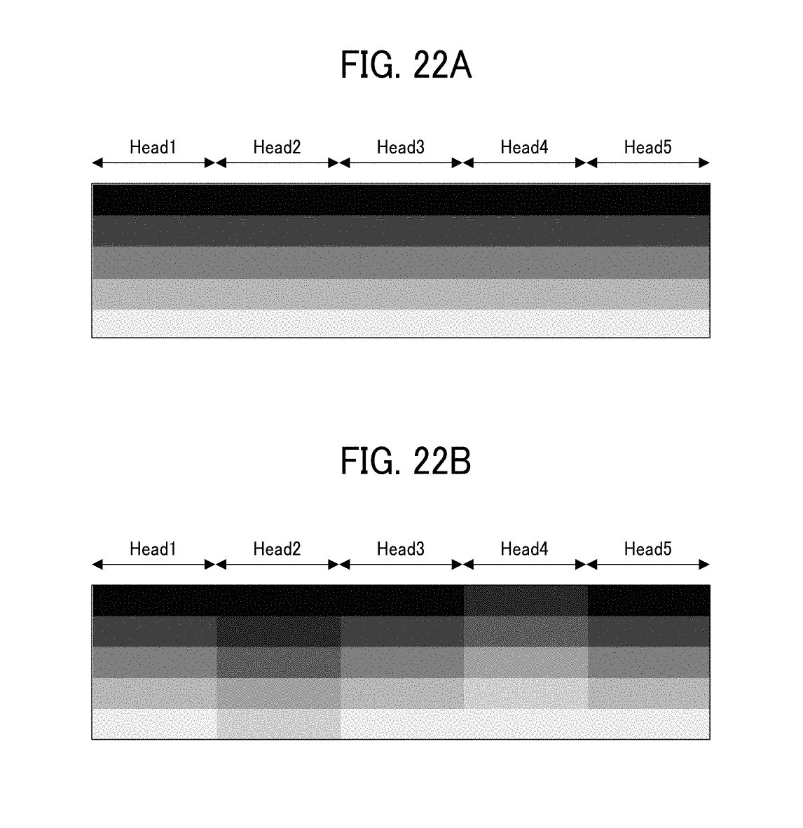

In an original data illustrated in FIG. 22A, the gradation adjuster 143 instructs the head controller to create the image data in which columns in the gradation chart are filled by the density in fifth steps of 20%, 40%, 60%, 80%, and 100% from the bottom to top. Also in the gradation adjustment process in the present embodiment, the mixture ratio of droplet size is previously prescribed as illustrated in Table 7. The mixture ratio is varied according to the types of the medium to be used or types halftone pattern. The numerical value in Table 6 is only an example.

However, even the original data is equalized as illustrated in FIG. 22A, the density unevenness may be occurred between the heads H1 to H7 as illustrated in FIG. 22B. When the density unevenness is occurred between the heads, the gradation adjuster 143 changes the density parameter (%) of the specific head as illustrated in Table 2 to change the density ratio. Accordingly, the constituting ratio of droplets discharged by the heads is changed, and the number of droplets discharged for each droplet size is also changed.

TABLE 7

| | H1, H3, H5, Correction | H2 | H4 |
|---|---|---|---|
| | unnecessary | Adjusted | Adjusted |
| | (Large droplet:middle droplet: | to thinner | to thicker |
| | small droplet:No discharge) | direction | direction |
| 100% | P100/90:10:0:0 | P95/80:10:0:5 | P105/95:5:0:0 |
| 80% | P80/ 0:30:0:20 | P75/35:40:0:25 | P85/60:25:0:15 |
| 60% | P60/10:50:0:40 | P55/5:45:5:45 | P65/15:50:0:35 |
| 40% | P40/0:15:25:60 | P35/0:5:30:65 | P45/0:25:20:55 |
| 20% | P20/0:0:20:80 | P15/0:0:15:85 | P25/0:0:25:75 |
| 0% | — | — | — |

Here, the head generally heats with printing operation. Thus, the ink temperature in the head also gradually increases. When the ink temperature changes, the viscosity of ink changes. The degree of change of the discharge amount caused by the viscosity change in ink is different for each droplet size.

As a comparative example, the number of ink droplets may be changed as illustrated Table 2, and the constitution ratio of droplet size may be changed to correct the density difference between the heads. However, even when the density difference between the heads is uniformed during inspection by the comparative example, the density difference may stand out as printing time passes.

By contrast, the present embodiment performs gradation adjustment after correcting the discharge amount between the heads as described above, the density difference between the heads is already greatly reduced.

As described-above, when the gradation chart (halftone image) is made during executing the gradation adjustment process, the waveform corrector 63 corrects the drive waveform using the corrected magnification stored in the initial-value storage 68 and outputs the corrected drive waveform as illustrated in FIG. 4. Then, each of the heads H1 to H7 discharges the ink droplets of the corrected discharge amount at the timing corrected by the timing signal.

In this way, the scanner 140 reads the gradation chart (halftone image) formed by the heads, the magnification and the landing position of which are corrected. Thus, even when slight error occurs, the density difference between the heads does not increases as illustrated in Table 22B. For example, only a small amount of discharge amount is corrected as illustrated in Table 8.

TABLE 8

| | H1, H3, H5, Correction | H2 | H4 |
|---|---|---|---|
| | unnecessary | Adjusted | Adjusted |
| | (Large droplet:middle droplet: | to thinner | to thicker |
| | small droplet:No discharge) | direction | direction |
| 100% | P100/90:10:0:0 | P99/89:10:0:1 | P101/92:8:0:0 |
| 80% | P80/50:30:0:20 | P79/48:31:0:21 | P81/53:28:0:19 |
| 60% | P60/10:50:0:40 | P59/7:49:3:41 | P61/13:48:0:39 |
| 40% | P40/0:15:25:60 | P39/0:12:27:61 | P41/0:18:23:59 |
| 20% | P20/0:0:20:80 | P19/0:0:19:81 | P21/0:0:21:79 |

In the adjustment in Table 8, the adjustment of constitution ration of 1% is performed as an example. Further, the amount of density adjustment of 1% as illustrated in Table 8 is less than the amount of adjustment of density adjustment of 5% as illustrated in Table 7 in terms of amount of adjustment in the constitution ratio (change in number of droplets that is discharged for each droplet size).

That is, in the step S3, a test pattern is printed in the condition where drive magnification of the identical waveform is varied. The magnification correction value is applied to entire heads according to the scanned results. Thereby, the density (ink discharge amount) of entire head can be controlled within the target range in the step S4. Further, the adjustment of density parameter (%) that specifies the constitution ratio of droplet size in the gradation adjustment can be minimized in the gradation adjustment process.

In this way, the present embodiment corrects the magnification of amplitude of the drive waveform for each heads before executing the shading correction to equalize the ink discharge amount between the heads during outputting (printing) the identical specific pattern (identical droplet constitution). The rate of change in discharge amount during temperature increase can be adjusted between the heads because the printing of each gradation is performed with the substantially identical constitution ratio of the droplet after the shading correction based on the above-described magnification correction.

Thereby, not only just after the inspection but also after when temperature changes over time, the present embodiment can prevent the generation of the density unevenness. Therefore, even when the present embodiment is applied to the production printing that performs large amount of printing, for example, it is possible to guarantee the stable image quality from the beginning to the end of the production printing.

Variation

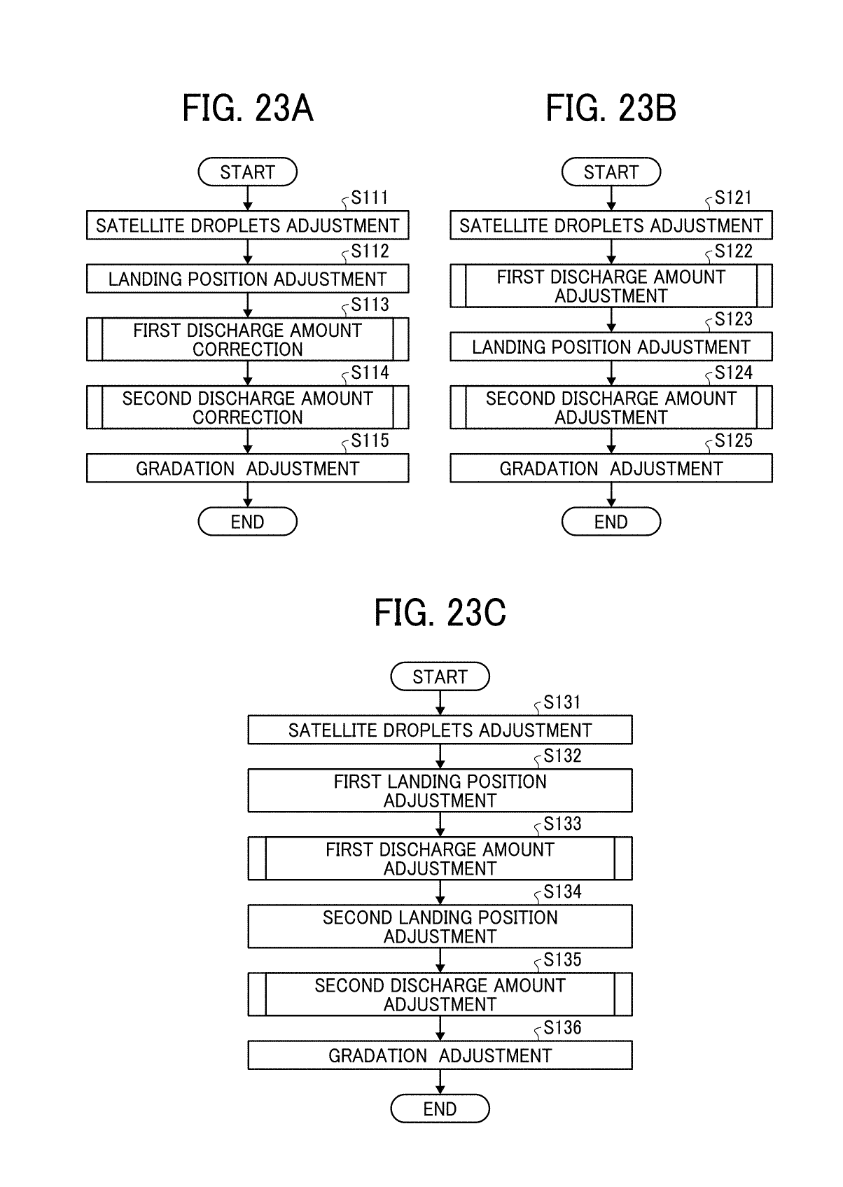

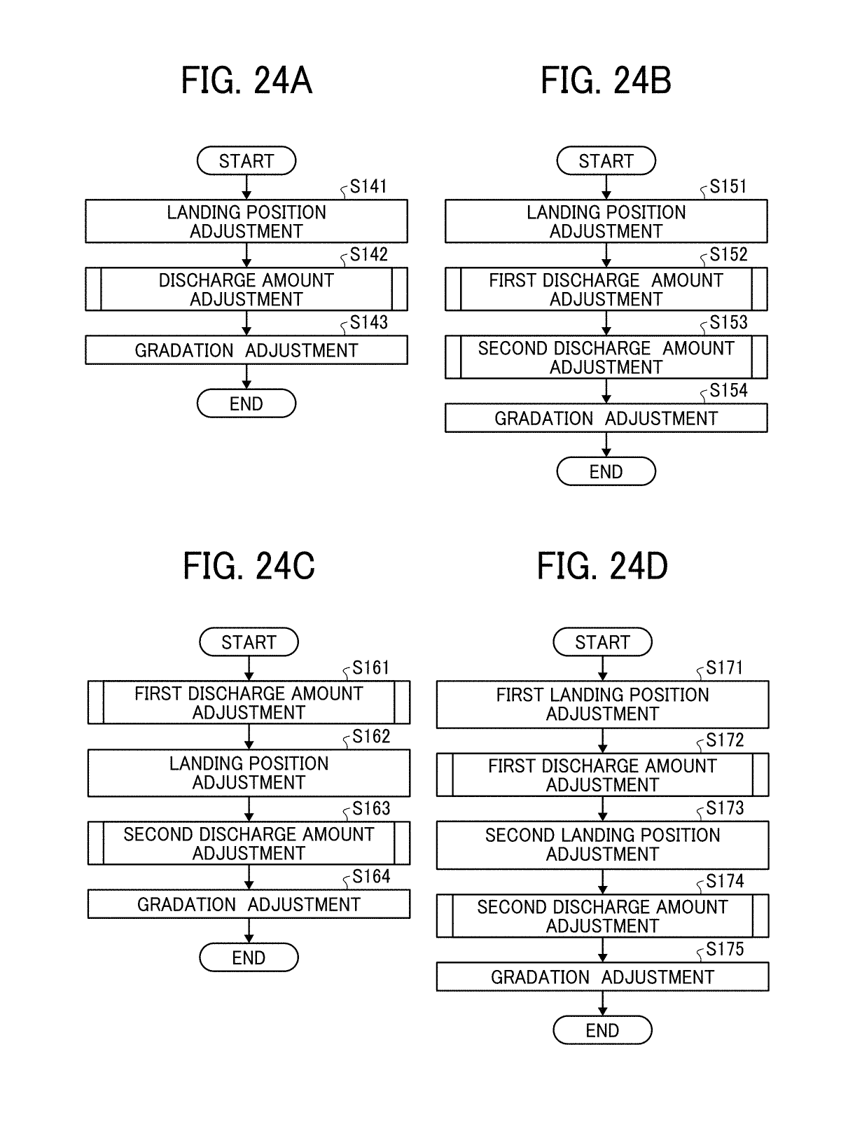

FIGS. 23 and 24 illustrate flowcharts of a variation.

As illustrated in FIGS. 23A through 23C, the ink discharge amount correction between the heads as described in step S3 in FIG. 5 may be executed twice. When the ink discharge amount correction between the heads may be performed two consecutive times as illustrated in FIG. 23A. The landing position adjustment may be executed between the two processes of the ink discharge amount correction between the heads as illustrated in FIGS. 23B and 23C.

Further, the landing position adjustment as illustrated in FIG. 9 may be executed plurality of times. When the ink discharge amount correction between the heads may be performed two consecutive times as illustrated in FIG. 23A.

When the ink discharge amount correction between the heads is executed twice, identical type of ink discharge amount correction may be executed twice. Further, the ink discharge amount correction according to the first embodiment and the third embodiment may be combined in random order. Further, the ink discharge amount correction according to the second embodiment and third embodiment may be combined in random order.

Further, as illustrated in FIGS. 24A through 24D, the satellite droplet adjustment may be omitted. Especially, the first embodiment as described in FIGS. 10 through 12 can detect the satellite droplets. Thus, in the first embodiment, the satellite droplet adjustment as illustrated in step S1 in FIG. 5 may be omitted as illustrated in FIGS. 24A through 24D.

Except for the existence of satellite droplet adjustment, FIG. 24A corresponds to FIG. 5, FIG. 24B corresponds to FIG. 23A, FIG. 24C corresponds to FIG. 23B, and FIG. 24D corresponds to FIG. 23C.

As described in the above-noted variation, the density unevenness (discharge amount difference) between the heads and between the nozzles in the same head can be accurately corrected by executing the ink discharge amount correction between the heads and the landing position adjustment for a plurality of times.

Preferred embodiments of the present disclosure have been described heretofore; however, the present disclosure is not limited to the described embodiments and various modifications are possible within the scope of the appended claims unless explicitly limited in the description.

What is claimed is:

1. An inkjet apparatus comprising:
a plurality of heads to discharge droplets from a plurality of nozzles of the plurality of heads to form an image on a medium;
a head driver to generate a drive waveform to discharge the droplets from the plurality of nozzles of the plurality of heads;
a scanner to read a specific pattern from the image on the medium formed by the droplets discharged from the plurality of nozzles of the plurality of heads; and
a discharge amount adjuster to correct the drive waveform to reduce differences in discharge amount of the droplets between the plurality of heads according to the specific pattern read by the scanner.

2. The inkjet apparatus according to claim 1, wherein the discharge amount adjuster corrects the drive waveform to equalize the discharge amount of the droplets between the plurality of heads.

3. The inkjet apparatus according to claim 1, wherein the discharge amount adjuster sets a magnification of an amplitude of the drive waveform for each of multiple droplet sizes to correct the drive waveform.

4. The inkjet apparatus according to claim 2, wherein the discharge amount adjuster corrects the drive waveform of a head of the plurality of heads to be matched with the drive waveform of another head of the plurality of heads, which is smaller in the discharge amount than the head.

5. The inkjet apparatus according to claim 1, wherein the plurality of heads discharges droplets to form the specific pattern that includes at least one of a dot and a line when a resolution of the scanner is higher than a resolution of the image formed by the plurality of heads, and
the discharge amount adjuster detects a size of the specific pattern to calculate the discharge amount to correct the drive waveform.

6. The inkjet apparatus according to claim 1, wherein the plurality of heads discharges droplets to form groups of specific patterns that form a cyclic arrangement pattern when a resolution of the scanner is lower than a resolution of the image formed by the plurality of heads, and
the discharge amount adjuster detects a density of the cyclic arrangement pattern to calculate the discharge amount to correct the drive waveform.

7. The inkjet apparatus according to claim 1, wherein the plurality of heads discharges droplets to form a gradation chart including a plurality of halftone images, having different densities, when a resolution of the scanner is higher than a resolution of the image formed by the plurality of heads; and
the discharge amount adjuster detects the densities of the halftone images to calculate the discharge amount to correct the drive waveform.

8. The inkjet apparatus according to claim 7, wherein the discharge amount adjuster reduces differences in the densities of the halftone images between the heads by correcting a magnification of an amplitude of the drive waveform.

9. The inkjet apparatus according to claim 8, wherein the plurality of halftone images is formed by discharging the droplets from the plurality of heads while changing the drive waveform by lowering the magnification of the amplitude of the drive waveform with respect to a set value of the drive waveform without changing a mixture ratio of droplet size of the droplets.

10. The inkjet apparatus according to claim 1, wherein the discharge amount adjuster corrects the discharge amount when an initial setting of the plurality of heads is performed or when at least one of the plurality of heads is exchanged.

11. The inkjet apparatus according to claim 1, further comprising:
a satellite droplets detector to detect satellite droplets in the droplets discharged from the plurality of nozzles; and
a reference-waveform magnification-setting section to calculate and set a magnification of an amplitude of the drive waveform so that a number of the satellite droplets decreases.

12. The inkjet apparatus according to claim 1, further comprising a landing position detector to correct a difference in landing position of the droplets on the medium between the plurality of heads by adjusting discharge timing of the plurality of heads.

13. The inkjet apparatus according to claim 1,
wherein the plurality of heads discharges droplets to form a plurality types of the specific patterns, and
the discharge amount adjuster corrects the drive waveform for each of the plurality types of the specific patterns.

14. A method for density correction in an inkjet apparatus, the method comprising:
discharging droplets from a plurality of nozzles of a plurality of heads to form an image on a medium;
generating a drive waveform to discharge the droplets from the plurality of nozzles of the plurality of heads;
reading a specific pattern from the image on the medium formed by the droplets discharged from the plurality of nozzles of the plurality of heads; and
correcting the drive waveform to reduce differences in discharge amount of the droplets between the plurality of heads according to the specific pattern.

15. An inkjet apparatus comprising:
a plurality of heads to discharge droplets from a plurality of nozzles of the plurality of heads to form an image on a medium;
a head driver to generate a drive waveform to discharge the droplets from the plurality of nozzles of the plurality of heads;
a scanner to read a specific pattern from the image on the medium formed by the droplets discharged from the plurality of nozzles of the plurality of heads; and
a discharge amount adjuster to correct the drive waveform to reduce differences in discharge amount of the droplets between the plurality of nozzles in a single head among the plurality of heads according to the specific pattern read by the scanner.
